(19) United States
(12) Patent Application Publication
(10) Pub. No.: US 2023/0054112 A1
(43) Pub. Date: Feb. 23, 2023

(54) SHAFT DRIVEN DEVICES WITH FEEDBACK

(71) Applicant: PRIME DATUM DEVELOPMENT CO., LLC, Canandaigua, NY (US)

(72) Inventors: PATRICK M. ROLLINS, CANANDAIGUA, NY (US); GEORGE M. LUCAS, BATH, NY (US)

(73) Assignee: PRIME DATUM DEVELOPMENT CO., LLC, CANANDAIGUA, NY (US)

(21) Appl. No.: 17/891,000

(22) Filed: Aug. 18, 2022

Related U.S. Application Data
(60) Provisional application No. 63/235,088, filed on Aug. 19, 2021.

(51) Int. Cl. B01F 35/212; B01F 35/214; B01F 35/22; B01F 35/222; B01F 35/32

(52) U.S. Cl. CPC B01F 35/212; B01F 35/214; B01F 35/2202; B01F 35/222; B01F 35/3204

(57) ABSTRACT

A direct drive batch mixing system including a vessel having an interior region for receiving a batch, a direct drive electric motor attached to at least one rigid point, a multi-axis load cell located between the motor and the rigid point to provide signals representing forces and moments in multiple axes, and an impeller located within the interior region of the vessel and engaged with the motor such that the motor rotates the impeller. Forces and loads on the impeller are directly supported by the motor and measured by the multi-axis load cell. In some embodiments, a programmable controller generates control signals that control the motor's speed (RPM), torque and direction of rotation, and receives feedback signals for adjusting the motor's speed and/or torque and/or direction of rotation.

### CROSS-REFERENCE TO RELATED APPLICATIONS

This application claims the benefit of the filing date of U.S. provisional application No. 63/235,088, filed Aug. 19, 2021, which application is incorporated herein by reference in its entirety.

### TECHNICAL FIELD

The present disclosure is related to industrial mixers, compressors, turbines, expanders and pumps.

### BACKGROUND

Industrial mixing is generally used to process and combine solids, liquids and/or gases in order to manufacture new products. Mixers used in food processing are combined with various attachments typically to reduce larger particles into smaller particles by blending, mowing, slicing, dicing, peeling, grinding, beating, mashing, smashing, cutting, emulsification, chopping and extruding (e.g., similar to a Kitchen Aid Mixer with numerous attachments). Mixers can also be used in waste processing such as drive units for waste water clarifiers, agitators and macerators. Mixers are used in diverse industries such as chemical production, food production and pharmaceutical production. Such uses of mixers are described in detail in the publication entitled “Fluid Mixing Technology”, by James Y. Oldshue, Chemical Engineering, 1983. For example, there are specific mixers for mixing paint, coatings, cement, adhesives, sealants, oil and gas. Mixers are also used in water treatment plants and wastewater treatment plants. Numerous conventional mixers and processes are configured to provide various combinations of speed and torque to an input device such as an impeller. A significant amount of effort is expended to design, test, characterize and validate impellers and shafts that are used in mixers and for specific processes. This is evident by the product catalog “NOV Chemineer Mixing Product Catalog”, National Oilwell Varco 1898-ENG-Rev02. Consequently, such impellers and shafts can be highly customized for a specific application. A common type of mixing involves a reaction tank with an impeller driven by a long unsupported drive shaft that mixes a batch of ingredients in the reaction tank in order to form a batch composition. For higher production applications, pipelines may be employed with static mixers installed inside the pipe where a pump provides pressure to flow the continuous mix through a static mixer or series of static mixers that are attached to the inside wall of the pipe or other fluid conduit. Turbulent mixing can require large amounts of torque to impart the required angular momentum into the mix. Shear rates, which are the velocity gradients at the impeller discharge, provide the forces to physically change a mixture. Shear is typically controlled by the speed of a given radial impeller diameter (tip speed), assuming the prime driver of the impeller has sufficient torque to overcome the viscosity of the batch. Batch viscosity can change during mixing thereby requiring adjustments in impeller torque and speed. Therefore, it can be difficult to match a catalog motor torque and speed to a specific process especially if the motor is a single speed motor that typically produces maximum torque at 100% speed. In all mixing processes, the viscosity and velocity of the ingredients are important to achieving the process results. For a prime driver, such as a motor, this means providing the required torque and speed for each process. When there is a change in the batch viscosity, the mixing system may have to be re-configured with a different impeller and motor in order to provide the proper mixing profile along with the proper torque and speed. Induction motors, which are well known in the art, are typically available at constant speed and torque and must be matched to the process requirements. Mixing parameters are matched at the design speed of the induction motor which is typically wherein the motor produces peak torque at 100% speed. For example, 100% speed could be 900 rpm, 1,800 rpm and 3,600 rpm. Induction motors are not inherently variable speed and provide speeds less than 100% design at a great cost to efficiency. When matching a motor to a process, it may be necessary to reduce the output of the process in order to accommodate the available motor torque and speed. If a Variable Frequency Drive (VFD) is used with an induction motor, the induction motor must be an inverter-rated induction motor. Inverter-rated motors are typically catalog motors with larger cooling fans and insulation for operation below 100% design speed. However, such inverter-rated motors generate a great deal of heat and operate at low efficiencies. In practice, the primary use of a VFD with an induction motor is to provide a soft start to a single-speed motor that may otherwise break or cause system damage during an “across the line start” where 100% speed and torque are applied at start-up. In most cases, impellers are designed to match the available rated speed and torque combination produced by the aforementioned catalog motors, which also operate at single speeds. Due to the limitations of the catalog motor, the impeller designer would need to use a smaller diameter rotor and reduce the throughput of the process. Many conventional direct-drive mixing systems use induction motors below 5 HP where the impeller's requirement for speed and torque is met by the catalog motor at 100% speed (e.g. Admix 100RXD). However, when the speed and torque are not met by a current art catalog motor, a gearbox, belt, pulley or other mechanical advantage system is required. A typical mechanical advantage system is a gearbox that can provide torque multiplication as well as speed reduction of a catalog motor but usually at a single speed. As discussed in the foregoing description, a VFD may be used with the single speed motor to provide a soft start to the single speed motor that may otherwise break or cause system damage during an “across the line start” at 100% speed and torque. In order to achieve proper operation of variable speed mixing systems using induction motor, gearboxes and VFDs, the variable-speed mixing systems must be configured in accordance with the maximum torque and speed of the system thereby providing very limited speed and torque ranges (see “Handbook of Industrial Mixing Science and Practice”, by Paul, et al, John Wiley Publisher, 2004). In addition, the induction motor must be protected from impeller inertial loads typically requiring a clutching mechanism to prevent the inertial load of the impeller from back driving the induction motor. Thus, without a braking system, this limits the induction motor system to one direction mixing unless the machine is stopped and reversed and it includes a gearbox that operates in both directions. Mixing gearboxes are highly engineered to mitigate leakage issues and are fitted with expensive seals to prevent gearbox leakage during processes. This is critical for processes that cannot tolerate any contamination, such as clean room applications, food and pharmaceuticals. Operators and owners of mixing systems must purchase expensive service contracts in order to maintain and rebuild these gearboxes on a regular basis. For reaction tanks, the typical mixer is comprised of a motor connected to an inline gearbox (or right-angle gearbox for higher horsepower application) which is connected to a long shaft that drives an impeller. Significant engineering resources and costs are expended to design the shaft and characterize the impeller design for the process. For example, significant Computer Aided Engineering (CAF) resources in combination with laboratory testing are used to validate and characterize the impeller for the intended process. In addition, shaft bending and torsional loading is a significant problem for viscous mixtures. Testing instrumentation can include shaft strain gauges and other sensors or gauges to measure pressure, temperature, viscosity and full flow field measurements. Such instrumentation includes DPIV (Digital Particle Image Velocimetry) and LDA (Laser Doppler Anemometry) to evaluate both instantaneous and time-averaged velocity vector fields and LIF (Laser Induced Fluorescence) for blending studies. After all of the design, testing and characterization, the process runs open loop without any feedback information from the impeller, shaft and motor regarding the batch composition.

What is needed is an inherently variable speed direct drive motor system that can eliminate leaking gearboxes and provide the required rotor-torque independent of rotor-speed to support custom impellers and higher production rates. What is also needed is a reliable and accurate system of control feedback that uses the extensive impeller design and characterization data to monitor, supervise the batch process and provide compliance to design process parameters which is paramount to food and drug safety.

### SUMMARY

This summary is provided to introduce a selection of concepts in a simplified form that are further described below in the detailed description. This overview is not intended to identify key features or essential features of the claimed subject matter, nor is it intended to be used in isolation as an aid in determining the scope of the claimed subject matter.

Various embodiments of direct-drive industrial mixers, compressors, turbines, expanders and pumps systems are disclosed herein. Given the amount of modeling and testing already invested to design an impeller and define a process, a feedback system using strain gauges and/or load cells that are isolated from the hazards of the batch provides a unique and novel way to monitor and supervise the process for compliance and as well as provide supervision including additional signals to correct the process. When combined with speed and rotor position sensors additional monitoring and supervision fidelity may be applied.

In an exemplary embodiment, the direct-drive device is an electric motor. A control system may be used with any of these embodiments. The motor systems and the sensors described herein provide feedback signals. These feedback signals may be directed to a PLC-type control system or a similar control system. The control system includes a direct-drive device controller, a signal conditioner and processor and a plurality of sensors including load cells or strain gauges, torque sensors, ultrasonic sensors, optical sensors, vibration sensors, flow sensors and temperature sensors. These sensors, load cells and strain gauges sense or detect a variety of parameters associated with the mixing, expanding or pumping processes and output signals representing the sensed parameters. These sensors are incorporated into the mixer, mixer-expander and pump systems. The mixer embodiments disclosed herein provide the novel concept of combining sensors, load cells and/or strain gauges with motor data to provide a comprehensive “batch or process feedback system” that provides process control, compliance and correction thereby providing the following functions:

a) controlling the process by measuring the process characteristics and/or as a function of time compared to a known (design) batch profile;
b) validating the process by measuring the process characteristics and/or as a function of time compared to a known (design) batch profile resulting in compliance (ISO9000); and
c) providing correction during the process when process characteristics are outside the process parameters.

At least one load cell or strain gauge can be used to provide impeller feedback and in its simplest form, run open loop. However, the best accuracy and fidelity results from mounting three coplanar multi-axis load cells equidistantly at 120 degrees apart, as shown in FIG. 2B herein. The direct-drive device controller outputs feedback signals which, along with the signals outputted by the motor and sensors, are processed by the signal processor in order to monitor, control and adjust the mixing, expanding and pump system process and to monitor the health of the system and individual components thereof. The signal processor generates correction signals that are based on the processed signals. The correction signals are fed back to the direct-drive device controller to effect any required adjustments to the motor system and/or batch or process system.

### BRIEF DESCRIPTION OF THE DRAWINGS

FIG. 1A is an elevational view of a load bearing, direct-drive mixer in accordance with an exemplary embodiment;

FIG. 1B is an elevational view, partially in cross-section, of the direct-drive mixer of FIG. 1A;

FIG. 1C is an elevational view, in cross-section, of the direct-drive mixer of FIG. 1A;

FIG. 1D is an elevational view of another embodiment of the load bearing, direct-drive mixer of FIG. 1A;

FIG. 2A is another elevational view of the load bearing, direct-drive mixer of FIG. 1A;

FIG. 2B is a top view taken along line 2B-2B in FIG. 2A;

FIG. 3A illustrates a rolling element bearing having load cells arranged about the bearing assembly to sense loads.

FIG. 3B illustrates a rolling element bearing housing having strain gauges arranged about the bearing assembly to sense loads.

FIG. 3C is a cross-sectional view taken along line 3C-3C in FIG. 3B;

FIG. 3D is a cross-sectional view taken along line 3D-3D in FIG. 3C;

FIG. 4 is an elevational view of a compact load bearing, direct-drive mixer in accordance with another exemplary embodiment;

FIG. 5 is an elevational view of the load bearing direct-drive mixer of FIG. 4 mounted within the interior of a conduit wherein the motor is attached or joined to the interior wall of the conduit:

FIG. 6 is an elevational view illustrating the load bearing direct-drive mixer of FIG. 5 positioned within a multi-channel conduit or pipe network having at least one flow inlet and at least one flow outlet, the mixer providing multi-channel mixing or blending;

FIG. 7A is a side elevational view of an over hung load bearing, direct-drive mixer in accordance with another exemplary embodiment;

FIG. 7B is a view taken along line 7B-7B in FIG. 7A;

FIG. 7C is an elevational view, partially in cross-section, of a mixer in accordance with another exemplary embodiment;

FIG. 7D is an elevational view of a mixer in accordance with another exemplary embodiment;

FIG. 7E is an elevational view of a mixer in accordance with another exemplary embodiment;

FIG. 7F is an elevational view of a direct-drive hybrid mixer system in accordance with another exemplary embodiment;

FIG. 7G is an elevational view of a load bearing, direct-drive mixer in accordance with another exemplary embodiment;

FIG. 7H is a side elevational view of a load bearing, direct-drive mixer in accordance with another exemplary embodiment, wherein the mixer has a rear bearing;

FIG. 7I is a view taken along line 7I-7I in FIG. 7H;

FIG. 8A is a side-elevational view, partially in cross-section, of a direct-drive radial mixer system in accordance with another exemplary embodiment;

FIG. 8B is a diagram illustrating the location and arrangement of load cells in the direct-drive radial mixer system of FIG. 8A;

FIG. 8C is a side-elevational view, partially in cross-section, of a direct-drive inline radial mixer in accordance with another exemplary embodiment;

FIG. 8D is a diagram illustrating the location and arrangement of load cells in the direct-drive inline radial mixer shown in FIG. 8C;

FIG. 8E. is a side elevational view, partially in cross-section, of a vertically mounted direct-drive radial mixer/expander in accordance with another exemplary embodiment;

FIG. 8F is a diagram illustrating the location and arrangement of load cells on the vertically mounted direct-drive radial mixer/expander shown in FIG. 8E;

FIG. 8G is a plan view of a direct-drive, closed loop process flow mixer and pump in accordance with another exemplary embodiment;

FIG. 8H is a side elevational view, partially in cross-section, of an inline radial mixer-expander in accordance with another exemplary embodiment;

FIG. 8I is cross-sectional view taken along line 8I-8I in FIG. 8H;

FIG. 8J is a cross-sectional view taken along line 8J-8J in FIG. 8H:

FIG. 9 is an elevational view, partially in cross-section, of a process flow radial mixer with an independent expander in accordance with an exemplary embodiment;

FIG. 10A is another elevational view, partially in cross-section, of the process flow radial mixer with independent expander of FIG. 9;

FIG. 10B is a cross-sectional view taken along line 10B-10B in FIG. 10A;

FIG. 10C is a cross-sectional view taken along line 10C-10C in FIG. 10A;

FIG. 11A is a side-elevational view, partially in cross-section, of a twin screw pump/mixer extruder in accordance with an exemplary embodiment;

FIG. 11B is an end view of the twin screw pump/mixer extruder of FIG. 11A;

FIG. 12A is a side-elevational view of a twin screw pump/mixer extruder in accordance with another exemplary embodiment;

FIG. 12B is an end view of the twin screw pump/mixer extruder of FIG. 12A;

FIG. 12C is a cross-sectional view of the twin screw pump/mixer extruder of FIG. 12A;

FIG. 12D is a side-elevational view, partially in cross-section, of a direct drive extruder in accordance with another exemplary embodiment;

FIG. 12E is an end view of the direct drive extruder of FIG. 12D;

FIG. 13 is a block diagram of a system that may be used to control the mixer, pump and expander embodiments disclosed herein;

FIG. 14 is a diagram of a direct-drive device for use with a mixer, expander or pump in accordance with another exemplary embodiment;

FIG. 15 is a side elevational view of a direct drive municipal drive for a clarifier in accordance with another exemplary embodiment;

FIG. 16 is a side elevational view, partially in cross-section, of a direct drive horizontal blender in accordance with another exemplary embodiment;

FIG. 17 is a side elevational view, partially in cross-section, of a mixer system in accordance with another exemplary embodiment;

FIG. 18 is a side elevational view, partially in cross-section, of a mixer system in accordance with another exemplary embodiment;

FIG. 19 is a diagram illustrating a strain gauge configuration.

FIG. 20 is a diagram of a mixer system in accordance with another exemplary embodiment and a corresponding force diagram;

FIG. 21 is a diagram of a mixer system in accordance with another exemplary embodiment;

FIG. 22 is a diagram of a direct drive mixer system in accordance with another exemplary embodiment; and

FIG. 23 is graph of torque as a function of time for a given process design.

### DESCRIPTION

As used herein, the terms “comprise”, “comprising”, “comprises”, “includes”, “including”, “has”, “having” or any other variation thereof, are intended to cover a non-exclusive inclusion. For example, a process, method, article or apparatus that comprises a list of elements is not necessarily limited to only those elements, but may include other elements not expressly listed or inherent to such process, method, article or apparatus.

As used herein, terms such as “vertical”, “horizontal”, “top”, “bottom”, “upper” “lower”, “middle”, “above”, “below” and the like are used for convenience in identifying relative locations of various components and surfaces relative to one another in reference to the drawings and that the mixer, expander and pumps systems disclosed herein may be installed and used in substantially any orientation so that these terms are not intended to be limiting in any way.

Reference in the specification to “an exemplary embodiment”, “one embodiment”, “some embodiments” “an embodiment” or “alternate embodiment” means that a particular feature, structure or characteristic described in connection with the embodiment is included in at least one embodiment of the invention. The appearances of the phrases “an exemplary embodiment”, “one embodiment”, “some embodiments”, “an embodiment”, or “alternate embodiment” in various places in the specification are not necessarily all referring to the same embodiment.

As used herein, the term “medium” shall refer to mixtures, liquids, solids and/or gas with or without a solid particulate, a batch composition, ingredients of a batch composition or other semi-solid matter or substance.

As used herein, the term “vessel” shall refer to a structure, conduit, pipe, container, machine, or other apparatus having an interior region for receiving a medium. The interior region may be configured to allow the medium to flow therethrough and/or hold the medium while it is being processed.

As used herein, the term “rigid point” refers to a boundary condition for load analysis in which displacements of the rigid point in the X, Y and Z axes are set to zero.

As used herein, “prime driver” shall mean an electric motor, hydraulic pump, gas engine, diesel engine, gas turbine, steam turbine, rocket engine, power turbine, hydrazine pump, windmill, water wheel, water turbine, and device that provides torque and speed to the input device such as the gearbox, torque multiplier or reducer device, speed reduction or multiplier device and/or impeller.

As used herein, the term “impeller” shall refer to the rotating device that causes movement and/or flow of a fluid, batch or other medium including but not limited to propulsive thrust. Such impellers, bladed devices, propellers and fans may be used in mixers that are used in waste processors, waste water clarifiers, agitators and macerators, chemical production, food production, pharmaceutical production and for mixing paints, coatings, cement, adhesives, sealants, oil and gas. In many mixer apparatuses, the impeller is connected to a shaft.

As used herein, the term “motor” shall mean any electric motor with a rotor and stator that creates flux. Suitable electric motors that may be used in one or more embodiments disclosed herein include, but are not limited to, permanent magnet motor architecture (regardless of motor control a.k.a. ECM vs. VFD, casing design a.k.a. staked lamination and manufacturing attributes such as PCB), synchronous reluctance motors, stacked laminated motors, induction motor, single speed Totally Enclosed Fan Cooled (TEFC) AC induction motor (e.g., asynchronous motor), variable speed TEFC AC induction motor, inverter-rated induction motor with VFD, switched reluctance motor, ECM Motor. PSC Motor, “inside-out-motor”, brushless DC motor, pancake DC motor, synchronous AC motor, salient pole interior permanent magnet motor, interior permanent magnet motor, PCB or Printed Circuit Board motor, finned-laminated permanent magnet motor, series-wound motor or universal motor, traction motor, series-wound field, brushed DC motor, stepper motor, and stacked lamination frame motor. Other types of suitable AC and DC motors include sinewave motors, hysteresis motors, step motors, reluctance motors, switched reluctance motors, synchronous reluctance motors, variable reluctance motors, hybrid motors, polyphase motors, single phase motors, wound rotor motors, squirrel cage motors, capacitor motors, shaded pole motors, DC permanent magnet commutator motors, homopolar motors, wound field motors, wound field shunt motors and compound wound field motors.

One or more of the embodiments disclosed herein may utilize combinations of a motor and gearbox wherein the motor is combined with a gearbox that provides torque multiplication and speed reduction. Such a combination exists wherein a gearbox or equivalent device, such as a Constant Velocity Transmission (CVT), provide more than one torque multiplier and reduction combinations with a relative speed multiplier and reduction combinations.

As used herein, the term “load bearing, direct-drive system” shall mean a drive system that comprises a load bearing, direct drive prime driver that has its shaft coupled to an impeller wherein the load bearing, direct drive motor provides the required torque and speed range for rotating the impeller while simultaneously supporting the impeller loads and maintaining the required gap between the rotor and stator in order to create flux. The load bearing, direct-drive system is configured to absorb thrust loads, oppose reverse thrust loads and oppose radial and yaw loads and moments.

One of more of the embodiments disclosed herein may be implemented with a load bearing electric motor. An example of a suitable load bearing electric motor is the load bearing permanent magnet motor is disclosed in U.S. Pat. No. 10,031,535 entitled “Direct Drive Fan System with Variable Process Control System”, issued Jul. 24, 2018. U.S. Pat. No. 10,031,535 is hereby incorporated by reference in its entirety as if fully set forth herein. However, it is understood that other motor types can perform some or all of the duties described herein if properly equipped with mechanical advantage and/or speed modification devices such as gearboxes, braking systems, clutches, electronic power devices that modulate and manipulate motor current, voltage and frequency to achieve proper and independent control of torque and/or speed and/or direction and complimentary sensors, controls, feedback systems, monitoring, data storage devices and computational devices to provide reduction of data for system supervision and any type of telemetry for remote access and control via, network, wired, wireless and optical connection. The aforementioned U.S. Pat. No. 10,031,535 illustrates how parameters for various driven mixers may be measured and how feedback is used for control, quality and batch and continuous process confirmation.

One or more of the mixer embodiments disclosed herein may be implemented with a high variable torque controlled independent of variable speed electric motor in order to maintain the effected shear zone of the mixer. Mixers may be configured as load bearing or non-load bearing.

One or more of the embodiments disclosed herein may be implemented with a direct-drive device comprising an electric motor and a torque-multiplier device, wherein the electric motor drives the torque multiplier device and the torque multiplier device drives the impeller of the propeller, mixer, pump, turbine or expander. A direct-drive device having a motor and torque multiplier device is disclosed in U.S. Pat. No. 10,345,056, entitled “Direct-Drive System for Cooling System Fans, Exhaust Blowers and Pumps”, issued Jul. 9, 2019. U.S. Pat. No. 10,345,056 is hereby incorporated by reference in its entirety as if fully set forth herein.

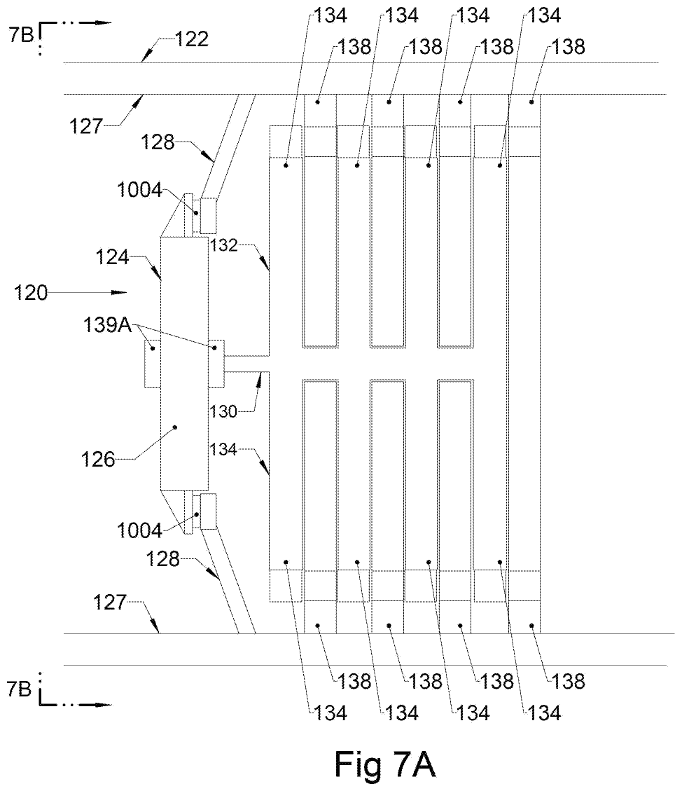

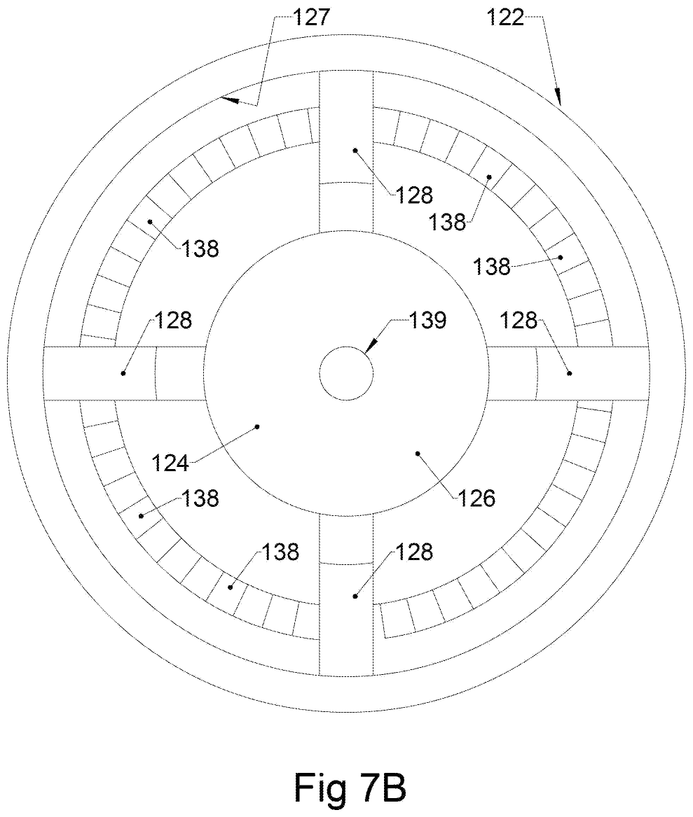

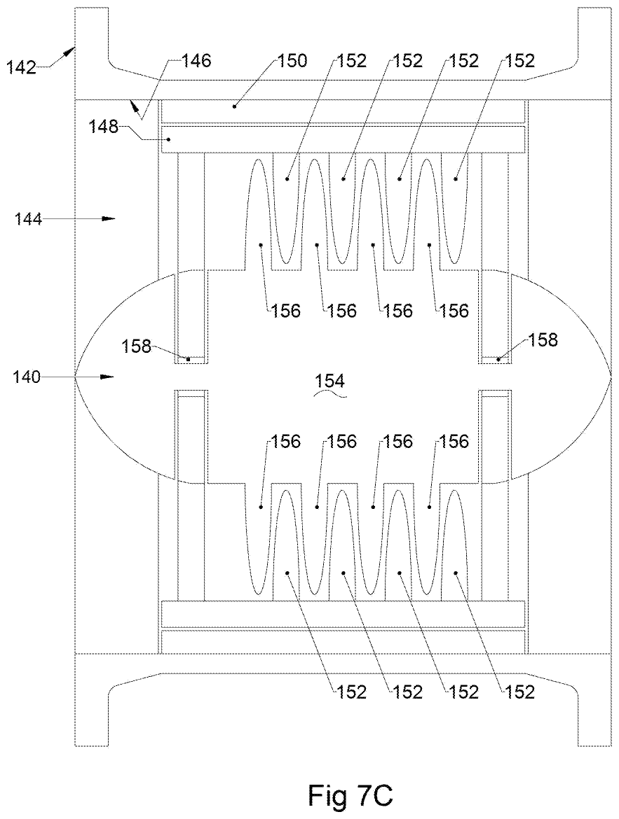

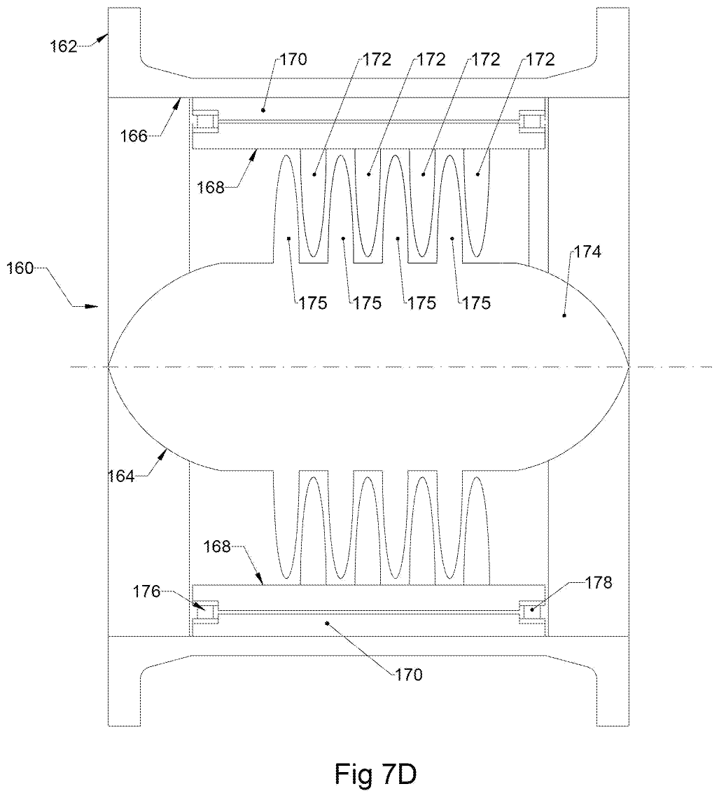

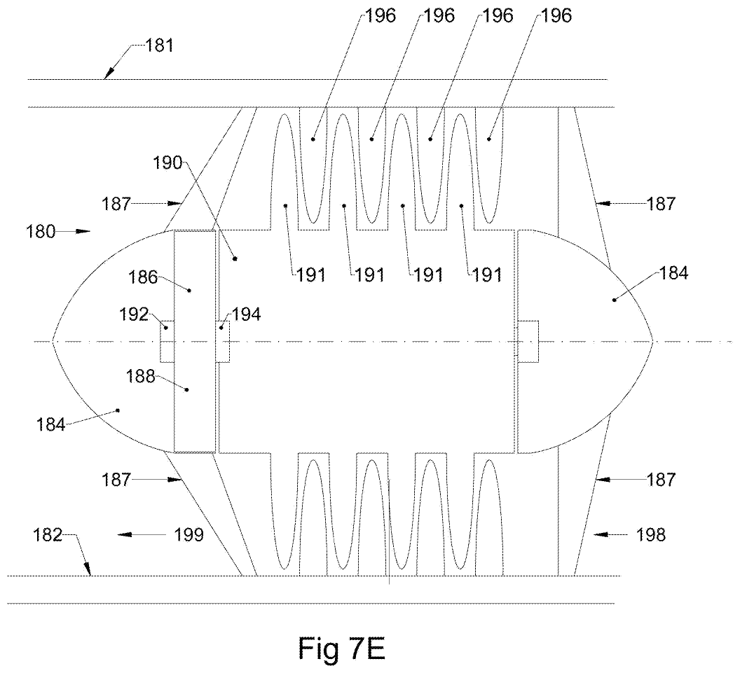

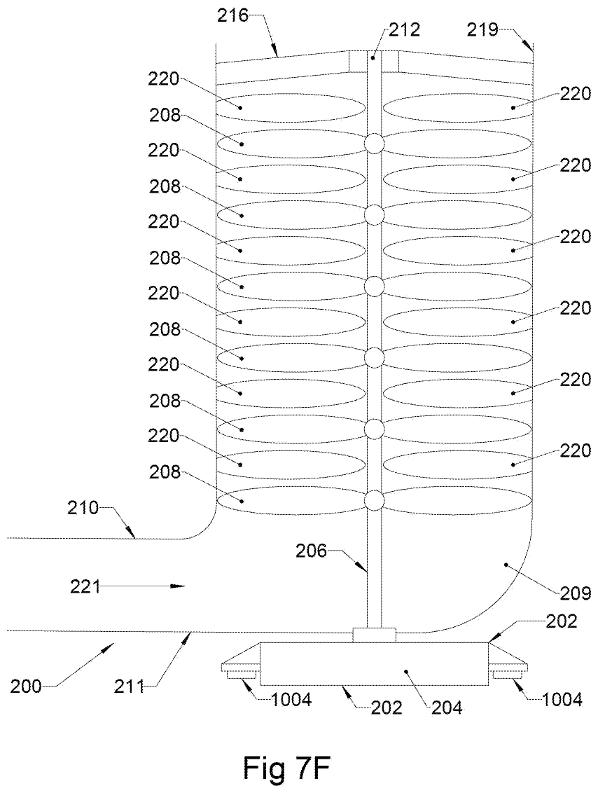

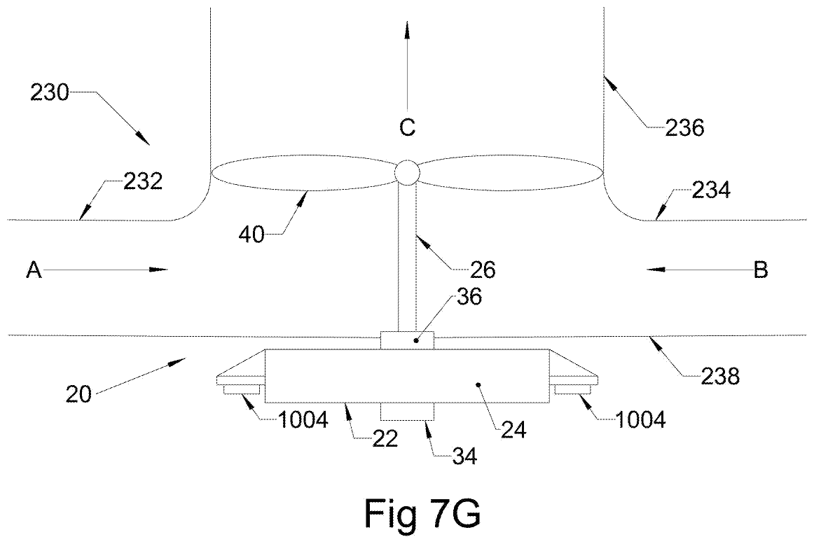

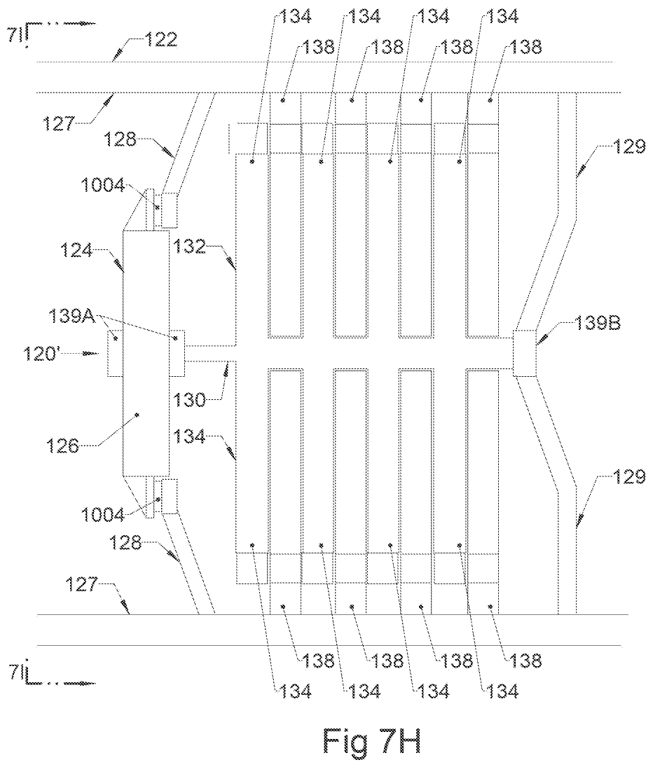

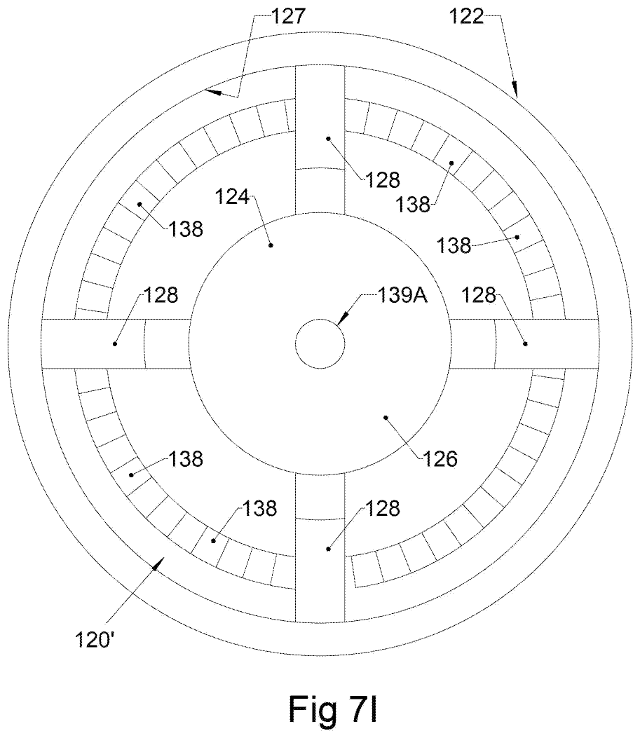

Alternate embodiments, as shown in FIGS. 7A-I and 8A-J, may be re-configured as turbines to extract energy from a continuous process while still providing mixing assuming that the head in the pipe is sufficient to drive the turbine and its shaft driven mixing elements. Such configurations in FIGS. 7A-I and 8A-J would assign the head driven turbine as the prime driver and still utilize the sensors as described. Multiple flow paths and/or combination mixer/turbine blades could be utilized to provide mixing while extracting energy from the pipe head to perform mixing.

One or more of the embodiments disclosed herein may be implemented with direct-drive device having an electric motor that incorporates one or more of the cooling schemes disclosed in U.S. Pat. No. 10,411,561 entitled “Cooling Schemes and Methods for Cooling Tower Motors”. U.S. Pat. No. 10,411,561 is hereby incorporated by reference in its entirety as if fully set forth herein.

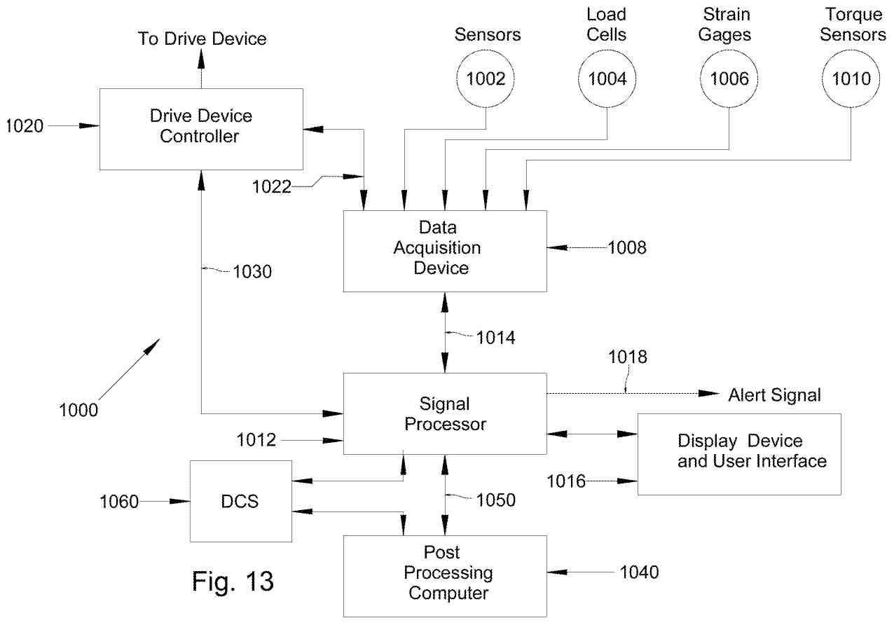

Any suitable control system may be used with any of the embodiments disclosed herein. For example, a programmable logic controller (PLC) or similar controller may be used to process any and all sensor signals and feedback. In an exemplary embodiment, control system 1000 shown in FIG. 13 may be adapted for use with any of the embodiments disclosed herein to monitor, supervise and correct any of the batch or process systems including the monitoring and supervisor of the overall health and efficiency of the driven system. Control system 1000 may be part of a larger Distributed Control System (DCS). For most direct drive systems, certain information such as shaft speed and torque can be derived directly from the motor system. This is an important feature for mixers because it eliminates the external sensors in the case wherein the sensors' reliability may be impacted by the batch chemicals or wherein the sensors present a sparking hazard to the batch when mixing combustible ingredients. As a result of the direct drive motor architecture, by example in permanent magnet motors, the relationship of the poles to motor control also allows measurement of rotor position, speed and torque. Since the direct drive impeller is coupled to a permanent magnet motor, a direct relationship is created between the motor system, the impeller and the resulting batch and/or continuous process system.

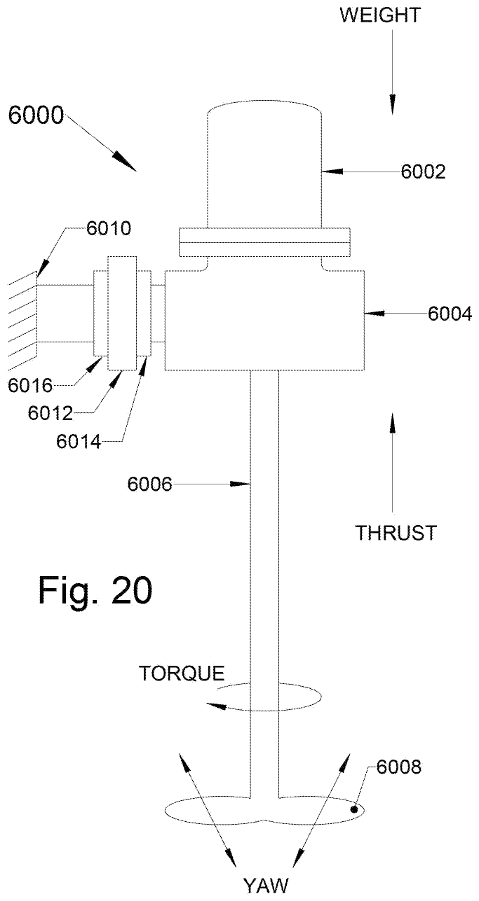

In an exemplary embodiment, control system 1000 comprises one or more sensors 1002, one or more load cells 1004, one or more strain gauges 1006 and one or more torque sensors 1010 to sense or detect a variety of parameters associated with the mixing, expanding or pumping systems disclosed herein. In an exemplary embodiment, load cells 1004 are multi-axis load cells. Control system 1000 further comprises data acquisition device (DAQ) 1008 that is in electrical signal communication with sensors 1002, load cells 1004, strain gauges 1006 and torque sensors 1010. With reference to FIG. 20, any of the mixer, expander or pump system components, including batch vessels, conduits, pipes and volutes, that are disclosed herein may be equipped with a plurality of sensors 1002 for measuring parameters, attributes and characteristics associated with the mixers, expanders or pumps including, but not limited to: (x) thrust forces, (y) moments (z) motor (and impeller) rotational position, power, torque, speed, power factor, efficiency, voltage, current, frequency, torsion, torque and bending moments on the shaft, vibration of drive shafts associated with an impeller, propeller or other mechanical device such as a blade, vane or stator, vibration of input or output lines, pressure, and flow rate (e.g. rate of flow of batch or medium), fluid particulate, vibrations of the housing of the mixing vessel or tank, vibrations of the volute, temperature of bearings such as the prime driver, temperature of the housing of the conduits, pipes, mixing vessel or tank, and temperature of the volute. Load cells 1004 and strain gauges 1006 allow measurement and analysis of forces, compression, moments, bending, torsion, pressure, tension, weight and torque. In an exemplary embodiment, three multi-axial load cells 1004 are arranged in a coplanar orientation and are equidistantly mounted 120 degrees apart along a circle. Multi-axial load cells may be configured to read force and moments along the x, y and z axis and torque can be calculated from the forces of unique mounting configurations with additional post processing. Three coplanar load cells are utilized in several of the embodiments disclosed herein. In the case wherein a three coplanar load cells are not possible due to a mounting obstruction or if three coplanar load cells are not required (e.g., need only simple force analysis), then vector analysis or lesser accuracy and/or fidelity shall suffice based on the application. An example of a suitable commercially available load cell is the MTA600 Tri-Axial Load Cell manufactured by Sensel Measurement of Vincennes, France.

In one or more of the embodiments disclosed herein, the load cell 1004 may be configured as a six (6) axis load cell to read force (F) and moment (M) vectors (F_{X}, F_{Y}, F_{Z}, M_{X}, M_{Y}, M_{Z}). A suitable commercially available six (6) axis load cell is the 6A Series 6-Axis Standard Capacity Load Cell (F_{X}, F_{Y}, F_{Z}, M_{X}, M_{Y}, M_{Z}) manufactured by Interface Force Measurement Systems.

In any of the embodiments disclosed herein, ultrasonic sensors may also be used in conjunction with or as alternatives to load cells and strain gauges based on the application requirements. Such ultrasonic sensors could also be in electronic signal communication with data acquisition device 1008.

A suitable sensor network for detecting vibrations in the motor shaft and detecting heat or temperature in the bearings or the bearing housings is disclosed in the aforementioned U.S. Pat. No. 10,031,535 entitled “Direct Drive Fan System with Variable Process Control System”. System 1000 includes static and/or rotary torque sensors 1010 to measure the torque on the impeller shaft of the motor or other drive-device used in the mixers, expanders or pumps disclosed herein. Such torque sensors are also in electrical signal communication with DAQ device 1008. Examples of suitable commercially available torque sensors are optical torque sensors, the SM2000 Rotary Torque Sensor, the SM2300 Rotary Torque Sensor, the Series 3000 Rotary Torque Sensor and the Series 4000 Rotary Torque Sensor, all of which being manufactured by Sensel Measurement of Vincennes, France.

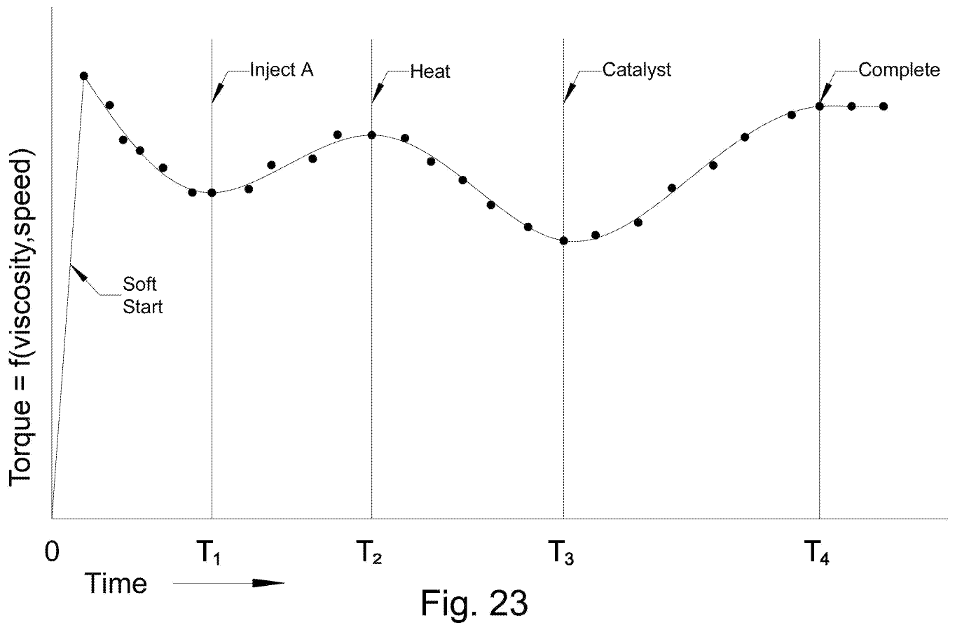

Control system 1000 further comprises signal processor 1012 that is in data signal communication with DAQ device 1008 via electronic data signal bus 1014. DAQ device 1008 acquires the signals from the sensors 1002, load cells 1004, strain gauges 1006 and torque sensors 1010 and then conditions these signals. The conditioned signals are then routed to signal processor 1012 over electronic signal data bus 1014. In an exemplary embodiment, signal processor 1012 has one or more programmable processors, one or more data storage or memory devices (e.g., RAM and ROM) and interface circuitry to allow communication with the Internet and wireless and optical networks. In an exemplary embodiment, signal processor 1012 comprises a parallel processing platform. Signal processor 1012 processes the feedback and/or conditioned signals to determine values based on the sensed parameters and then compares the determined values to predefined, known or accepted values for the batch or continuous process profile. The comparison of the determined values to predefined or known values determines whether the batch conforms to the system process design or if corrections need to be made to the batch process. For example, by trending and recording each batch via the computer data storage, variance of the batch process according to the graph shown in FIG. 23 may be evaluated. Other trending analysis would include system efficiency and/or energy usage of the mixing, chopping and pumping processes. Based on the feedback from the sensor or sensors, the health of the motor system and other components can be determined and improved by adjustments to the system, replacement of the components, such as the impeller, and improvements to the process design based on the trending and comparison of real time data to the batch design specifications. FIG. 23 is discussed in detail in the ensuing description.

Referring back to FIG. 13 in an exemplary embodiment, display device and user interface 1016 comprises a graphical user interface (GUI) such as touch-sensitive computer screen to allow operators to input commands and other information. Signal processor 1012 is configured to implement numerous signal processing algorithms for analyzing sensed parameters and provide status information, graphs, charts and alerts to display device 1016. Signal processor 1012 also generates alert signals 1018 that alert owners, operators and other personnel of important, significant or critical changes in component and system performance. Alert signals 1018 may be in the form of wireless signals, email messages, or SMS (Short Message Service) messages or MMS (Multi-Media Messaging) that may be sent to Smart Phones, remote computers, the Cloud or other computer devices that are in electronic signal communication with signal processor 12 via a network such as a LAN or WAN.

In some embodiments, encoders, sensors 1002, load cells 1004, strain gauges 1006 and torque sensors 1010 are in electrical signal communication with signal conditioner and/or DAQ device 1008 by electrical cables and wires. In other embodiments, sensors 1002, load cells 1004, strain gauges 1006 and torque sensors 1010 are in electrical signal communication with DAQ device 1008 via wireless or optical techniques, such as wireless sensors and strain gauges. In such embodiments, DAQ device 1008 is configured to receive wireless communication signals. In other embodiments, sensors 1002, load cells 1004, strain gauges 1006 and torque sensors 1010 are in electrical signal communication with DAQ device 1008 via a combination of electrical cables or wires and intermediate devices (e.g., routers) for converting sensor or strain gauge signals into wireless signals that are received by a separate router in electrical signal communication with DAQ device 1008.

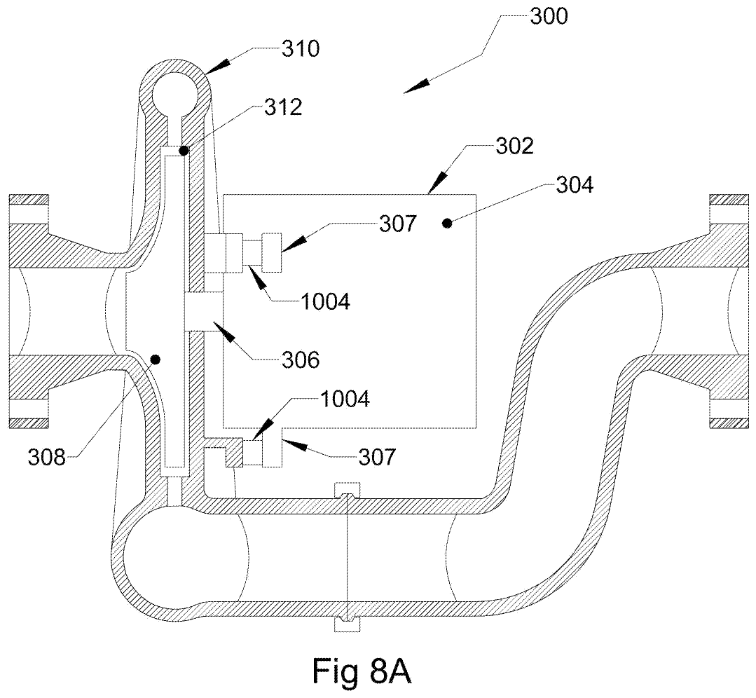

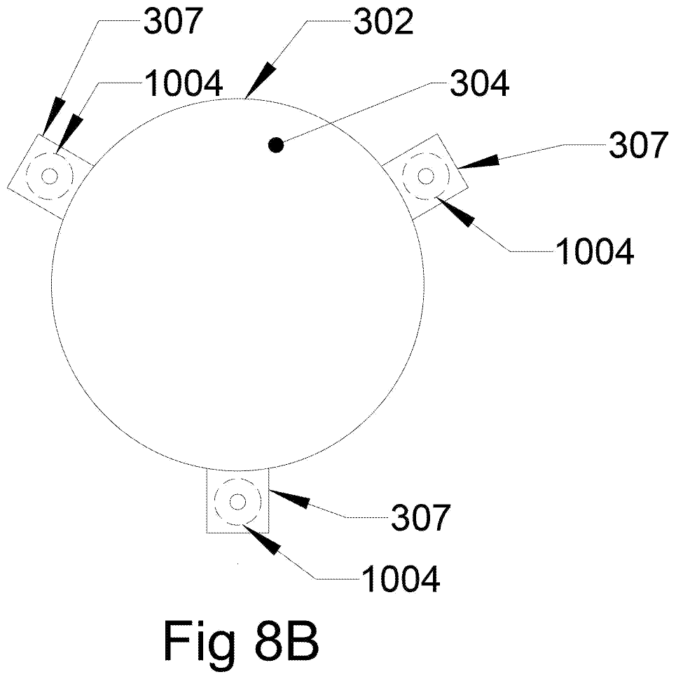

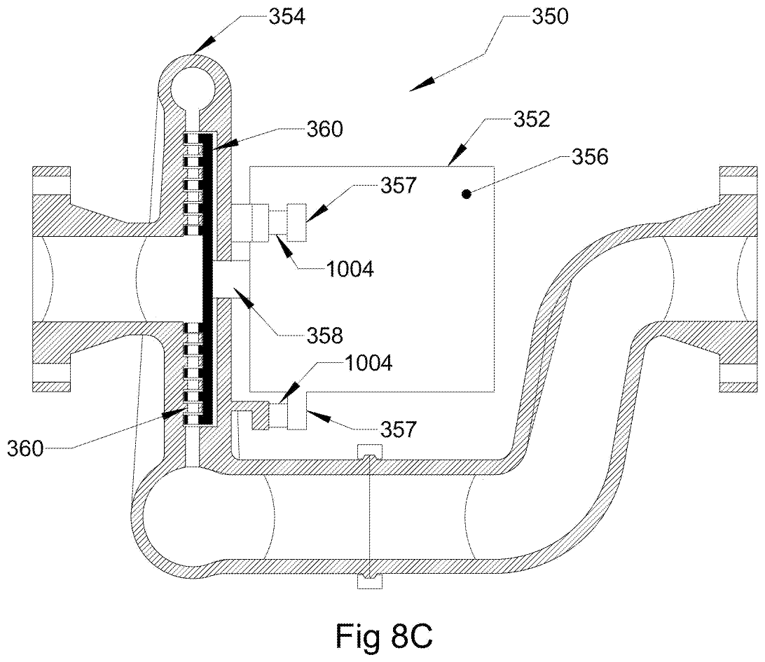

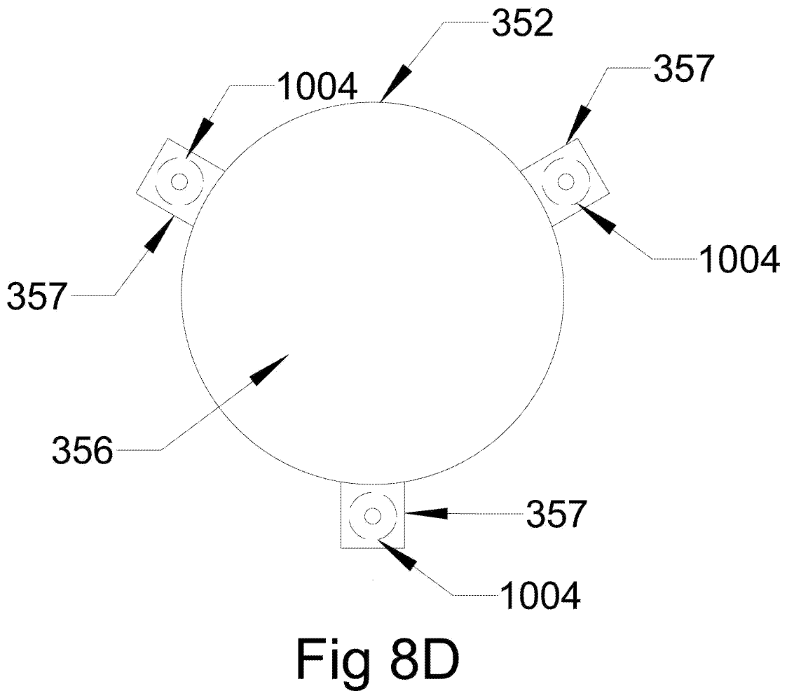

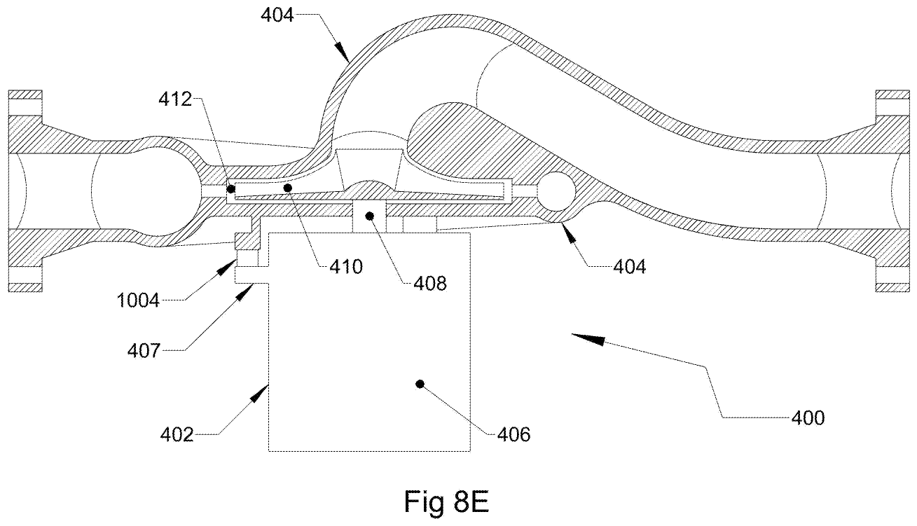

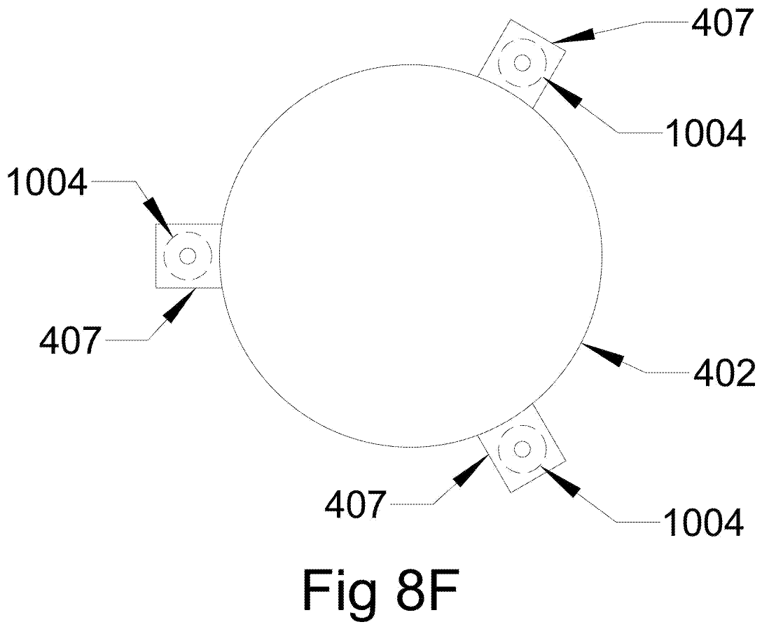

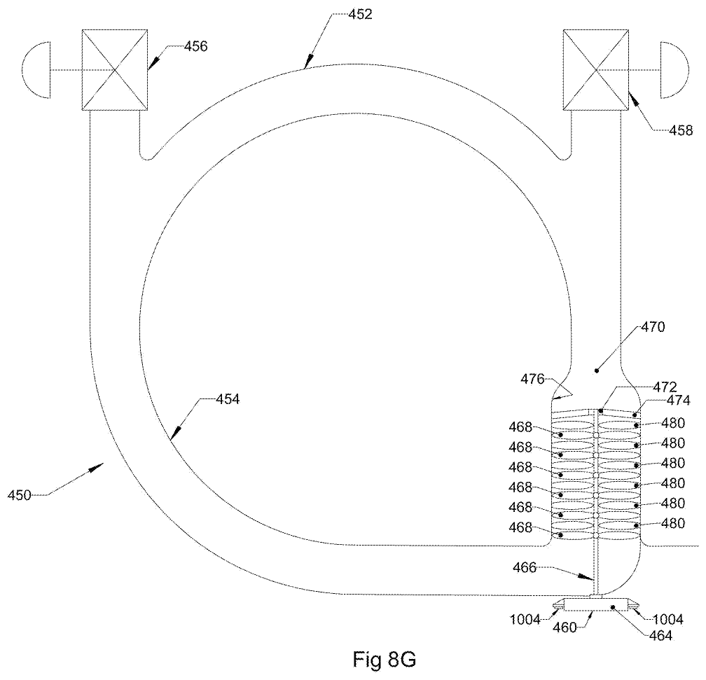

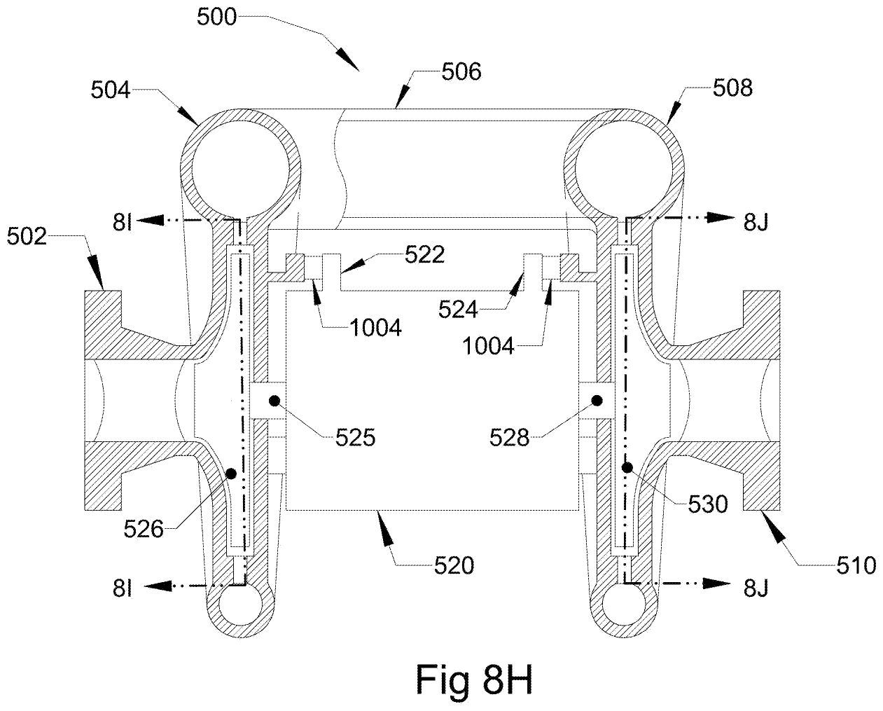

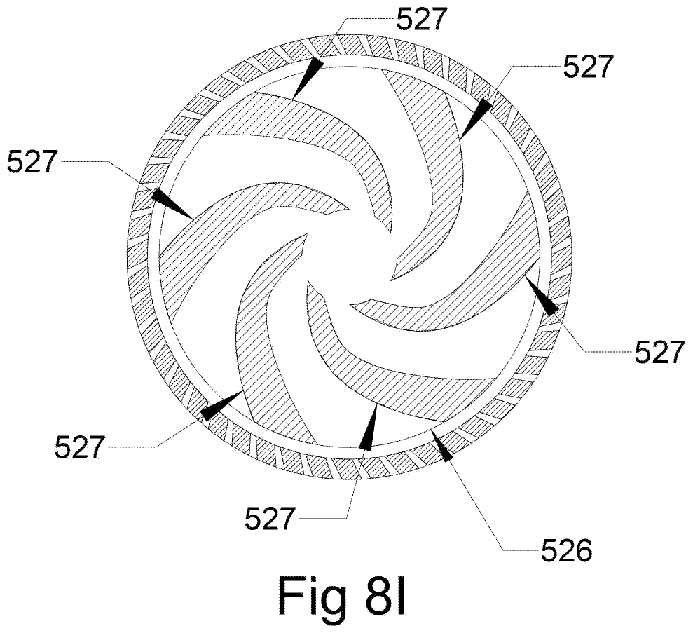

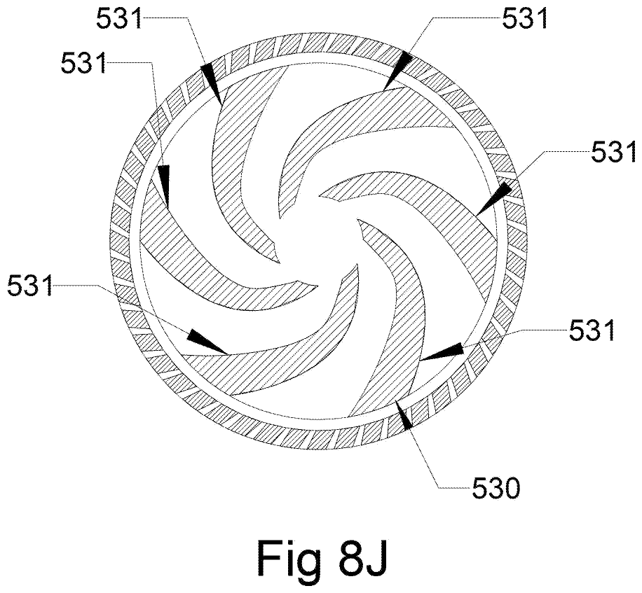

Control system 1000 includes drive device controller 1020 that provides electrical power and control signals to an electric motor or other prime drivers. Drive device controller is in electrical signal communication with DAQ device 1008 via data signal bus 1022 and is also in electrical signal communication with signal processor 1012 via data signal bus 1030. Drive device controller 1020 outputs feedback signals over data signal bus 1022 for input into DAQ device 1008. These feedback signals provide current “real time” motor speed (RPM) or impeller speed, electrical voltage draw, electrical current draw, Power factor, motor efficiency, motor torque and rotational direction such a forward or reverse (i.e., clockwise or counter clockwise). Drive device controller 1020 may be a programmable motor controller, Variable Frequency Drive (VFD) device, ECM, PLC, Variable Speed Drive (VSD), Intelligent Motor Controller (IMC), Frequency Drive Inverter (FDI), Electronic Frequency Controller (EFC), Pulse Width Modulation (PWM) controller or Phase Lock Loop (PLL) controller and may be positioned on the motor. in proximity to the motor or remotely located from the motor. Drive device controller 1020 is configured to control motor speed (RPM), initiate starting and stopping, rotational direction (i.e., reverse, clockwise, counterclockwise), positioning, torque and horsepower. Drive device controller 1020 is configured to control the torque independent of the motor speed and control the motor speed independent of the torque. Signal processor 1012 generates control signals for drive device controller 1020. These control signals are routed to drive device controller 1020 via data signal bus 1030 and may function as control signals to control motor speed (RPM), initiate starting and stopping, initiate Lock-Out Tag-Out (LOTO), determine direction of rotation (i.e., reverse, clockwise or counter clockwise), pre-position the impeller, control torque and control horsepower. These control signals may also function as correction signals that adjust the motor speed, motor torque, direction of rotation (clockwise or counter-clockwise) as well as a generate additional signals such as signals to initiate a heater or heating cycle, initiate a cooler or cooling cycle, add additional catalyst, add additional ingredients and then route the batch to the “fixer mixer” shown in FIG. 8G to remix the batch into compliance. Specifically, signal processor 1012 processes the signals provided by sensors 1002, load cells 1004, strain gauges 1006 and torque sensors 1010 and the feedback signals provided by drive device controller 1020 and in response, generates the correction signals that will cause drive device controller 1020 to monitor and provide supervision to adjust the motor system operation in response to changing conditions of the processes such as changing environmental temperature and/or equipment wear and tear such as backlash. Drive device controller 1020 is also configured to initiate rotation of the impeller (by example) in accordance with a pre-programmed acceleration rate and to slow the speed of the impeller in accordance with a pre-programmed deceleration rate. Drive system controller 1020 may also be configured to brake and hold the motor for replacing the impeller. In an exemplary embodiment, drive system controller 1020 is configured to implement the LOTO (Lock-Out-Tag-Out) function that is described in the aforementioned U.S. Pat. No. 10,031,535 entitled “Direct Drive Fan System with Variable Process Control System”.

In some embodiments, an absolute position encoder is used with a prime driver in order to accurately determine the rotor position, and similar encoders are used to determine speed. In such embodiments, the position and speed encoders may be mounted on the motor shaft. The output or feedback of the position and speed encoders may be provided directly to a PLC, DAQ device 1008 or may be first provided to drive device controller 1020 and then routed to DAQ device 1008 via data signal bus 1022.

As discussed in the foregoing description, sensors 1002 include vibration sensors that monitor and supervise atypical, unexpected or resonant vibrations in the drive devices (e.g., motors), support structure, auxiliary systems, the impeller and shafts, the inflow and outflow pipes or conduits and the volutes. The vibration sensors output signals may be used as an on/off signal by a PLC or are acquired and conditioned by DAQ device 1008 and then processed by signal processor 1012. In some instances, signal processor 1012 may generate correction signals for input into drive device controller 1020 in order to control the motor to avoid or skip over motor (RPM) speeds that create resonant frequencies in the system. In some cases, the vibration sensor feedback may shut down the motor system entirely as a safety issue. In such cases, the control system will generate a log of the occurrence and notify the operators of the fault via the Distributed Control System (DCS) 1060, text message or e-mail.

Control system 1000 includes post-processing computer 1040 which is in electronic signal data communication with signal processor 1012 via data signal bus 1050. Post-processing computer 1040 processes feedback data provided by signal processor 1012 and provides an analysis relative to the process design. Such analysis takes into consideration the particular system components and the characteristics of the batch, such as the environmental conditions, density, viscosity, particulate content and flow rate. This analysis may be useful for modeling new impellers, chopper disks, radial shearing and pumping systems or determine when they need to be replaced.

In some embodiments, post-processing computer 1040 uses data from the process design such as Computational Fluid Dynamics (CFD), or is combined with real time process data from Laser Doppler Anemometry (LDA), Particle Induced Velocimetry (PIV) and/or lab testing of the process batch to determine conformity to process design.

Impeller feedback is similar to the flight of an aircraft where the forces on the shaft of the propeller or jet engine will react to the smooth flow of air, turbulence such as in a thunderstorm, full load power via thrust on takeoff and yaw loading from a cross winds. All of these forces and moments will result in feedback signals on the propeller shaft, bearings and resultant load cells or strain gauges. These “flight conditions” are important in mixing and provide feedback to our process design parameters and real time process trending for batch conformation and compliance. However, unlike where flying in a thunderstorm is not desired, turbulence is required in mixing to combine ingredients. As noted, turbulence can be designed via CFD and characterized by lab testing (Laser Doppler Anemometry (LDA), Particle Induced Velocimetry (PIV)) and can now be monitored and supervised by the feedback of the load cells and/or strain gauges providing compliance to the process design.

Thus, control system 1000 provides the data for batch compliance and certification as well as evaluates the health of the overall process system as well as individual components of the systems. Control system 1000 utilizes known or custom reliability algorithms to predict and avoid potential downtime issues by trending and analyzing the variance in the process. Reliability algorithms and trending are discussed in aforementioned U.S. Pat. No. 10,031,535 entitled “Direct Drive Fan System with Variable Process Control System”. For example, signal processor 1012 processes the signals provided by torque sensors 1010 to determine shaft torsion and mounting, and the bearing load cells 1004 determine bending on the driveshaft by the impeller, whether in the mixing, agitation, expanding or pump modes. The determined torsion may then be compared to predefined, normal or expected torsion based on the specific geometry of the impeller for a specific batch and driveshaft and the specific installation and location of these components in the mixer, expander or pump system. A typical torsion may cause significant stress on the driveshaft and may be indicative of other technical problems with the system. Sensors 1002 also monitor inflow and outflow pipes or conduits to detect atypical or unexpected flow rates and particulate content. The data provided by sensors 1002, load cells 1004, strain gauges 1006 and torque sensors 1010 is also used by signal processor 1012 to measure the viscosity of a batch. Changes in the viscosity of a batch composition may cause changes in impeller loads. For example, as components of a batch are mixed certain batch compositions may actually amplify impeller loads such as thrust, torque, shaft torsion and bending while the density of other batch compositions may dampen those loads. Sensors 1002 detect these loads and provide sensor output signals that are processed by signal processor 1012 to determine the cause of the changes of the impeller loads. If necessary, signal processor 1012 generates the appropriate alert signals 1018. Sensors 1002 also sense or detect vibrations in the shaft, temperature values or heat in the motor bearings or in the bearing housings and output sensor signals that are processed by signal processor 1012 to determine the cause of the changes in loading. If the sensed heat and/or loads exceed pre-set thresholds or maximum permissible levels, signal processor 1012 may generate an emergency shut-down signal that stops the operation of the mixer, expander or pump system and generate alert signals 1018 that alert operators, DCS (Distributed Control System) 1060 and personnel of the situation. The emergency-shut down signal would be sent to drive device controller 1020 via data signal bus 1030 and DCS 1060. Such load detection and analysis scheme is disclosed in the aforementioned U.S. Pat. No. 10,031,535 entitled “Direct Drive Fan System with Variable Process Control System”.

Referring to FIG. 20, there is shown mixer system 6000 in accordance with an exemplary embodiment. Mixer system 6000 comprises electrical motor 6002 that drives gearbox 6004. Gearbox 6004 drives impeller shaft 6006. Impeller 6008 is attached to impeller shaft 6006. In some embodiments, impeller 6008 is integral with shaft 6006. Motor 6002 may be either a single speed or variable speed motor. Motor 6002 may be a commercially available motor. Mixer system 6000 is mounted to rigid point 6010. Flange load cell 6012 is located between gearbox mounting flange 6014 and rigid mounting flange 6016. In a preferred embodiment, flange load cell 6012 is a six-axis flange load cell. In an alternate embodiment, flange load cell 6012 is a single axis strain gauge. The six-axis flange load cell 6012 being located at rigid point 6010 isolates and protects the load sensors from the batch and protects the batch from contamination whereas conventional strain gauges located on the impeller shaft detach and become part of the batch. In other embodiments, mixer system 6000 uses more than one load sensor. FIG. 20 also shows that the expected forces and moments on mixer system 6000 may be resolved from the feedback signals provided by flange load cell 6012. Such feedback signals enable the calculation of: (a) dead weight of the mixer (to resolve thrust calculation), (b) thrust load from the impeller, (c) side loading or off axis from the impeller which may depend on the impeller design and (d) torque of the impeller reacted through the rigid mounting. From these readings and further testing and validation, we can derive to a certain degree of accuracy (a) shaft torsion from torque (b) shaft bending from side loads and (c) numerous data points about the batch such as batch viscosity. By monitoring these loads, we can then analyze batch characteristics as well as determine shaft and impeller wear and tear by applying failure analysis models. It is known that reading shaft torque may provide substantial benefits to measure viscosity of a batch. Any suitable load sensor may be used to read displacement, velocity and acceleration, including adding a vibration monitoring system. Depending on the importance of the application, fidelity of the feedback and required complexity of mounting, numerous arrangements from one gauge (or strain, displacement, velocity or accelerometer, or equal sensor) to multiple point mounting and NEMA mounting can be designed and resolved through vector analysis. As shown in FIG. 20, utilizing a one-point mounting arrangement, that is assumed to be rigid in all degrees of freedom, a six-axis load cell may be configured at the load interface of the one-point mounting arrangement to read the following operating parameters:

a) Impeller Thrust: which can be derived from a strain gauge or the load cell incorporated with the one point rigid mounting system and also by a simple strain gauge on the mount;

b) Shaft Bending: can be derived from a strain gauge or load cell incorporated with the one point rigid mounting system or by a combination of at least a strain gauge and vector analysis;

c) Shaft Torsion: can be derived from a strain gauge or load cell incorporated with the one point rigid mounting system or by a combination of at least a strain gauge and vector analysis;

d) Shaft Torque: can be derived from a strain gauge or load cell incorporated with the one point rigid mounting system or by a combination of at least a strain gauge and vector analysis.

By example, Axial loads can be aligned with the Vertical “Y” axis and radial loads with the 360 degree (polar) X axis, or with an X, Y, Z Axis where Z is the vertical axis and the radial plane is divided into an X and Y grid.

Simplified systems can be configured depending on the accuracy and/or fidelity required for the process. By example, some parameters such as impeller thrust may be determined based on the configuration with a single one-axis strain gauge. Other parameters such as moments for shaft bending can be calculated by knowing certain mounting configuration dimensions combined with at least one strain gauge. These parameters can be “inputted” into a computer system, such as control system 1000, upon set up of the machinery or downloaded as a data set for certain impellers designs that have been highly engineered as described. For a single speed motor, speed can be determined by an encoder or similar device and the shaft speed of the gearbox determine by the ratio of the gearbox. In the alternative, it can be assumed that the single speed motor is constant if the accuracy and fidelity of the process allows. Likewise, torque can be measured by the load cells and/or strain gauges but can also be calculated through motor parameters. With motor speed known, torque can also derived by knowing the motor torque speed curve. Motor/shaft power can be calculated as a function of torque and speed but can also be calculated from motor parameters such as a function of voltage and current. In an exemplary embodiment, a torque sensor may be used with mixer system 6000 to measure torque. A suitable torque sensor is the RS425 Contactless Torque Sensor manufactured by Datum Electronics, Ltd. of the United Kingdom.

In the case of a motor driving a Constant Velocity Transmission (CVT), it is necessary to know the input and output speed of the shafts due to the known slip in the CVT which can be determined with encoders such as magnetic and optic encoders.

Custom and NEMA Mounting arrangements may be implemented with the load cells and stain gauges to provide process feedback based on the required accuracy and fidelity of the process from simple one-axis measurement systems to multiple-axis coplanar measurement system to an more complex vector analysis (post processing) when mounting configurations require asymmetric axis measurement systems.

In some embodiments, mixer system 6000 utilizes a non-load bearing single speed or variable speed motor with an inline gearbox. In other embodiments, mixer system 6000 may use a non-load bearing variable speed direct drive motor that utilizes a structure that supports and isolates the impeller loads and forces from the motor rotor and stator. In other embodiments, mixer system 6000 may use a non-load bearing single speed direct drive motor that utilizes a structure that supports and isolates the impeller loads and forces from the motor rotor and stator.

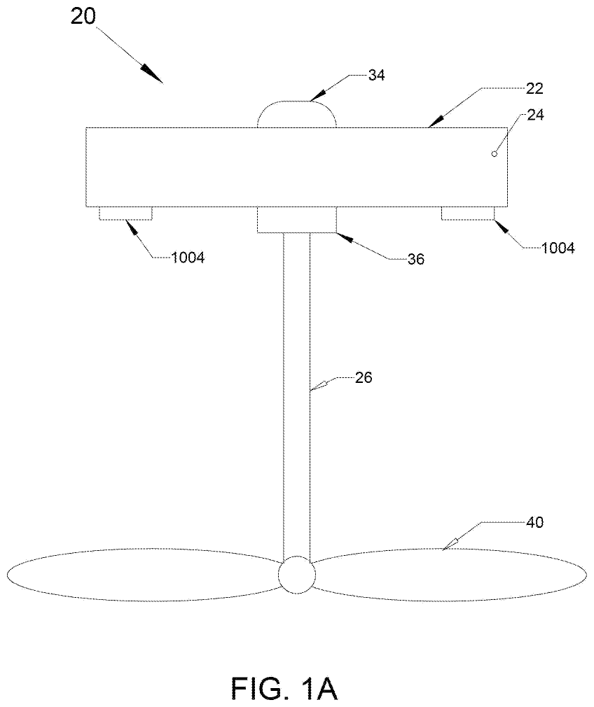

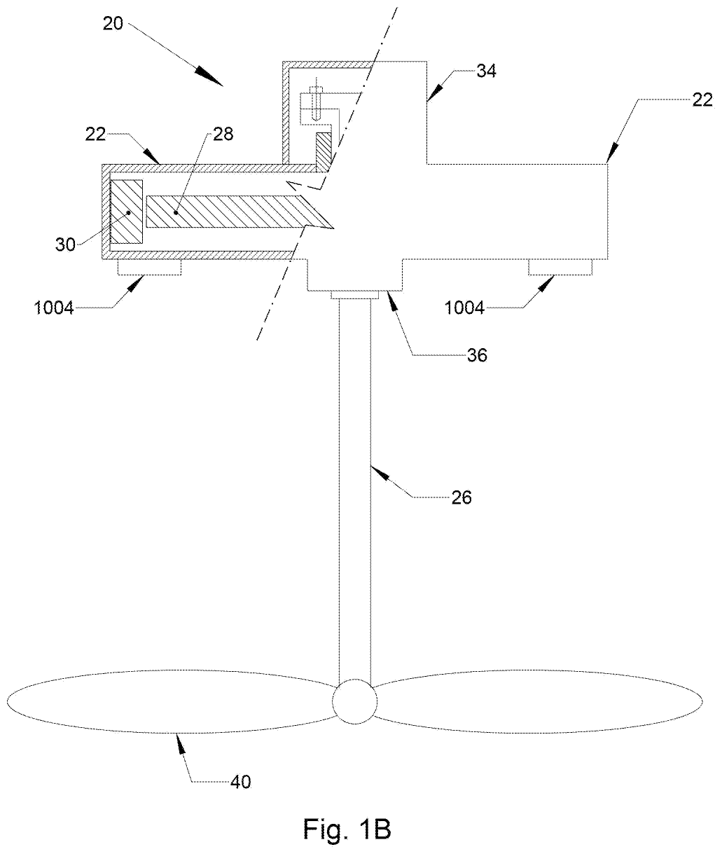

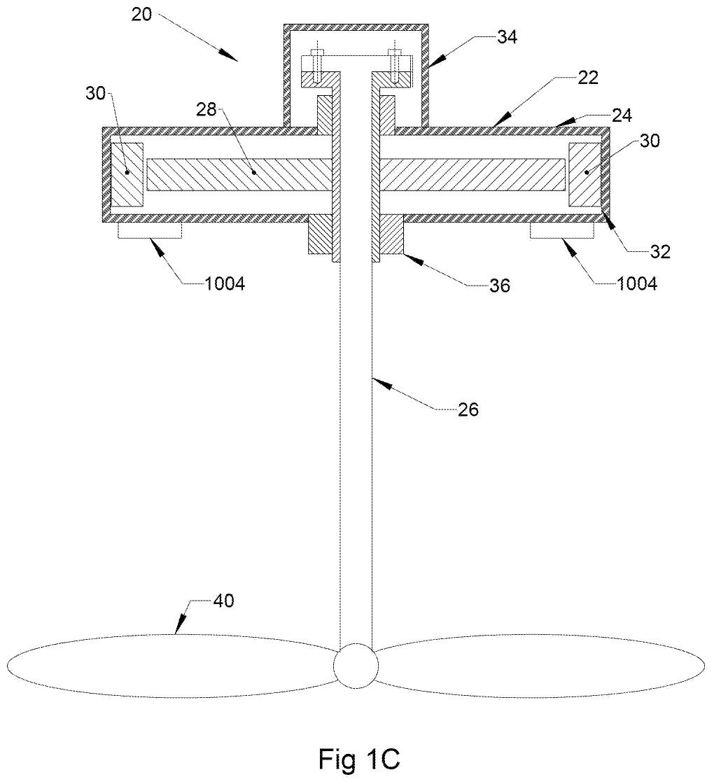

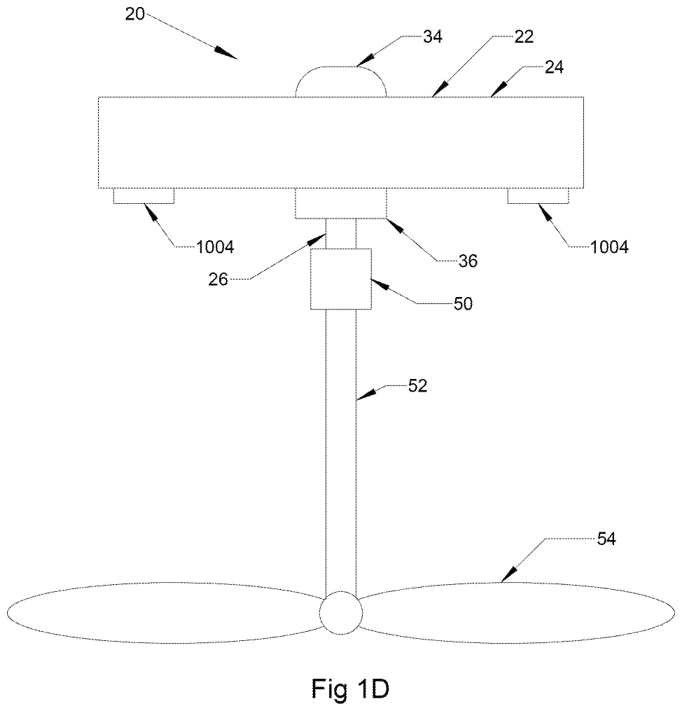

Referring to FIG. 1A, there is shown load bearing direct-drive system 20 in accordance with an exemplary embodiment. Direct-drive mixer 20 has a two-bearing arrangement that supports the loads of impeller 40 through the motor bearings and housings 34 and 36 while maintaining the critical rotor-to-stator gap to create flux and thus reliably rotate impeller shaft 26. In some embodiments, impeller shaft 26 and impeller 40 are not removable. In conventional systems, the loads are reacted through a gearbox, for example, or through an additional frame other than the motor shaft bearing system. Load bearing direct-drive system 20 may be used to implement a mixer, expander, pump, macerator, waste water clarifier and agitators. An example of a waste water clarifier is shown in U.S. Pat. No. 5,264,125, entitled “Clarifier Drive for Waste Water Treatment System”. In order to facilitate understanding of the novel features of this embodiment, load bearing direct drive system 20 is referred to as a direct drive mixer 20 in the ensuing description. Direct-drive mixer 20 may be arranged or installed in any orientation and may be single or variable speed. Direct-drive mixer 20 is in electrical signal communication with system 1000 that was described in the foregoing description. Direct-drive mixer 20 includes motor 22. Motor 22 may be single speed and/or controlled by a PLC and/or a drive device controller 1020 (see FIG. 13) discussed in the foregoing description. Motor 22 comprises housing or casing 24 and impeller shaft 26 which is directly connected to motor rotor 28 which is located within casing 24. In one embodiment, impeller shaft 26 is not removable from motor 20. In another embodiment, novel impeller 40 can be detached from the impeller shaft 26.

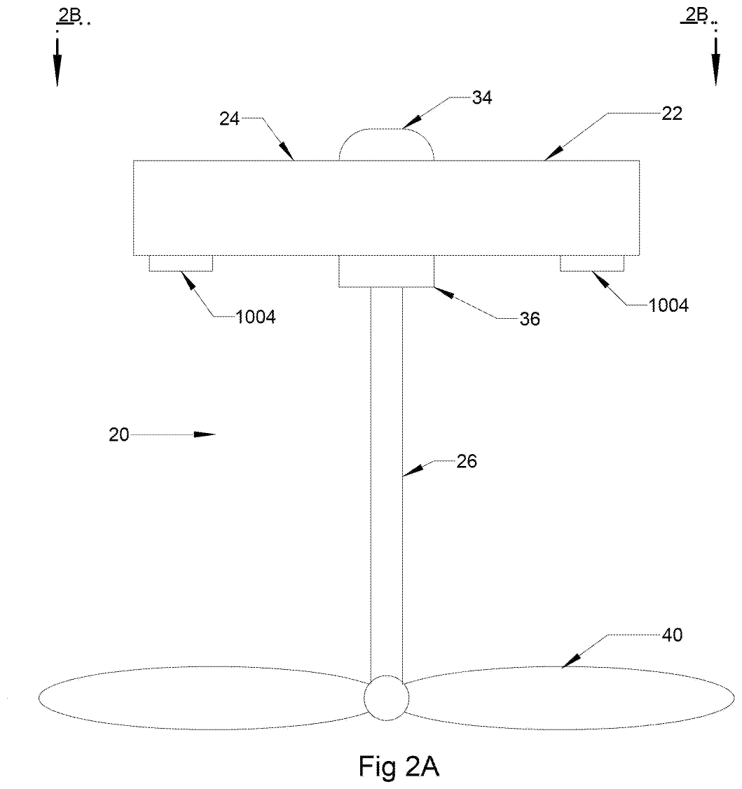

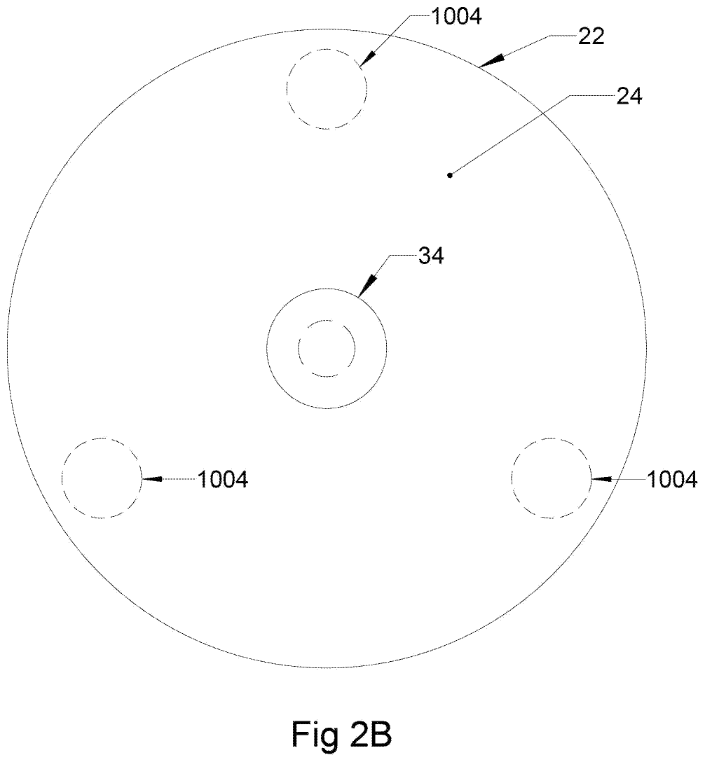

Referring to FIGS. 1B and 1C, load bearing direct drive motor 22 further comprises stator assembly 30 that is mounted or attached to interior wall 32 of casing 24. Motor 22 includes bearing housings 34 and 36 that house the motor bearing systems. The motor bearing systems supports shaft 26. Direct drive system 20 depicts a coplanar tri-axial load cell arrangement comprising three load cells 1040. In a preferred embodiment, a tri-axial load cell configuration (see FIG. 2B) provides the optimum in fidelity and resolving multi-plane load force mounting calculations. Direct drive mixer 20 is mounted at the three load cells 1004. In an exemplary embodiment, motor 22 is a permanent magnet motor (PMM) direct drive load bearing motor (or equivalent) that provides torque independent of speed and wherein motor torque (a.k.a. shaft torque) is derived directly from the motor pole data. Motor pole data can also provide rotor speed and position and where shaft power and real time energy monitoring can be calculated in control system 1000. Motor torque may then be compared and resolved against the load cell(s) torque for further analysis such as batch monitoring, supervision and compliance. FIG. 1C shows a removal one-piece shaft and impeller assembly that involves the shaft being inserted through the lower bearing structure 36 and in a preferred embodiment threaded and locked into a plate which bolts and attaches to the rotor.

Batch supervision, process system remote monitoring and diagnosis, expanded and improved process design, new applications and impeller designs can be discovered as a result of the use of load cells 1004. In other embodiments, load cells 1004 can be eliminated in lieu of the motor torque derived from the permanent magnet motor pole data.

In the embodiments shown in FIGS. 1A, 1B and 1C, direct drive mixer 20 is rigidly mounted by multi-axis load cells 1004. Although three equidistantly spaced multi-axis load cells 1004 are shown, it is to be understood that there may be more or less than three multi-axis load cells 1004. For example, a single strain gauge measuring a single load that outputs an on/off signal to a PLC may be all that is required for the application. However, the configuration of three coplanar multi-axial load cells 1004 spaced 120° apart provides for simpler mathematical computation of the forces to monitor and supervise the operation. Operational loads are reacted through the rigidly mounted multi-axis load cells 1004 and output electrical signals that are acquired by DAQ device 1008 (via the signal conditioner). The impeller loads such as thrust, torque, shaft bending and shaft torsion from mixing the medium (e.g., batch composition) are reacted through the rigidly mounted multi-axial load cells 1004.

Direct drive mixer 20 also includes the motor speed, heat/temperature and vibration sensors 1002 (not shown in FIGS. 1A-C) which were described in the foregoing description. In this embodiment, shaft 26 and impeller 40 are designed and tested for a specific process where the resultant flow field and forces imparted by the shaft and impeller assemblies on the batch composition are purposely designed, computer simulated with numerical and empirical analysis, laboratory tested and characterized for each shaft and impeller.

In an exemplary embodiment, direct drive load bearing mixer 20 provides the variable shaft torque independent of the variable speed to impart the required impeller forces and shear into the batch to deliver the purpose designed forces to mix the batch per the process design over a certain schedule of inputs and time. Real time motor data such as torque and speed can then be compared to load cells 1004 to confirm the impeller forces and speed met the design process specifications. Batch viscosity is directly related to impeller torque and can also be measured as a matter of conformance to the process design.

In an exemplary embodiment, drive device controller 1020 (see FIG. 13) gradually ramps up the speed (RPM) of motor 22, shaft 26 and impeller 40 in order to prevent component breakage during start-up. Since the motor speed and torque are now monitored and supervised, signal processor 1012 is able to control impeller torque and speed independently per the process parameters and schedule. This also provides a layer of safety so that impeller shaft loading limits are not exceeded during start-up limiting premature failure, high cycle fatigue and excessive wear and tear on drive components.

Signal processor 1012 measures feedback that can provide wear characteristics such as real-time ramp rates compared to design, system input torque to actual via load cells 1004, torque as a function of time, and rotor backlash measured by the position sensors in the PMM embodiment and/or through rotor position sensors and encoders. Numerous parameters and rates of change can be programed as drive system components and their wear characteristics are measured and established through the various feedback systems. System calibrations, compensations and initializations can be utilized to maintain the design process within specifications. Additional life assessment tools combined with treading data can be applied to flag component wear and service replacement intervals based on the measured feedback sensors such as forces, speed, and temperature, vibration, shock and schedule duration providing a system and component life assessment program for the operator.

In another embodiment, motor 22 is a variable speed motor and drive device controller 1020 varies the motor speed (RPM) and direction of rotation of motor shaft 26. In such an embodiment, drive device controller 1020 includes torque control and/or speed control and/or frequency control similar to an ECM Motor with a PLC controller. The feedback signals outputted by drive device controller 1020 provide the motor speed and torque which may then be processed by signal processor 1012 to determine or measure power from which energy consumption can be calculated and trended.

In another embodiment, motor 22 is a high torque, variable speed motor, such as an Electronically Commutated Motor (ECM) or a Permanent Magnet Motor (PMM), and drive device controller 1020 comprises a Variable Frequency Drive (VFD) and provides a range of independent torque that is independent of speed for various batch profiles. A permanent magnet motor provides constant high torque at any speed, wherein the torque and speed are controlled independently from one another.

In another embodiment, motor 22 is a high torque, variable speed motor that provides a range of torque and speeds for various batch composition profiles and can rotate shaft 26 clockwise or counterclockwise without bias and the need for a braking a system to stop and restart the rotor. One suitable motor for this embodiment is a permanent magnet motor.

It is to be understood that the embodiments shown in FIGS. 1A, 1B, 1C, ID and FIGS. 7A-I and FIGS. 8A-J may be configured as a pump, compressor and or propulsion system for aircraft, seagoing vessels and other platforms or vehicle requiring a propulsion system. It is to be further understood that any of the load cells and sensors described herein may be applied to numerous applications such propulsion systems for determining or measuring numerous parameters, including, but not limited to, torque, speed, thrust loads, radial loads and power.

Referring to FIGS. 2A and 2B, there is shown a direct drive mixer mounting in accordance with an exemplary embodiment. In this embodiment, this direct drive mixer mounting incorporates three multi-axis load cells 1004 which allow for measurement of forces and moments measurements in the X, Y and Z axes. These three multi-axis load cells 1004 are coplanar and equidistantly spaced apart by 120°. This configuration simplifies the vector analysis in determining forces and moments (voltage signal from gauge, converted to force, post process). Three coplanar load cells 1004 equidistantly spaced apart by 120° typically provide the best system fidelity and accuracy. However, it is to be understood that it is not mandatory that there be three load cells 1004, or that the load cells 1004 be equidistantly spaced apart or that the load cells 1004 be coplanar. Load cells 1004 may be positioned at different locations if there are physical constraints related to the mounting. Thus, in some mixer applications, a single strain gauge or load cell may suffice in providing the required feedback due to the required accuracy and/or mounting configuration. The load cells and/or strain gauges may be configured in accordance with custom and NEMA Mounting arrangements to provide process feedback based on the required accuracy and fidelity of the process. The load cells and strain gauges may be configured to provide feedback using complex vector analysis when particular mounting configurations require asymmetric axis measurement systems. Referring to FIG. 2B, multi-axial load cells 1004 are shown in phantom. The signals outputted by multi-axial load cells 1004 are acquired by DAQ device 2008 and then processed by signal processor 1012 to determine forces, moment, bending, torsion, thrust, torque and the yaw loads. The yaw loads have a direct relationship to shaft bending and are very important to mixing applications. Signal processor 1012 processes the signals provided by load cells 1004 with algorithms and empirical testing data and other signal processing software to determine the shaft bending load to the system. This would eliminate the need for a shaft strain gauge. Shaft strain gauges are undesirable because these gauges have poor reliability outside of the laboratory and could be affected by the batch chemistry or even contaminate the batch if the gauge is breached, broken and detached from its mounting.

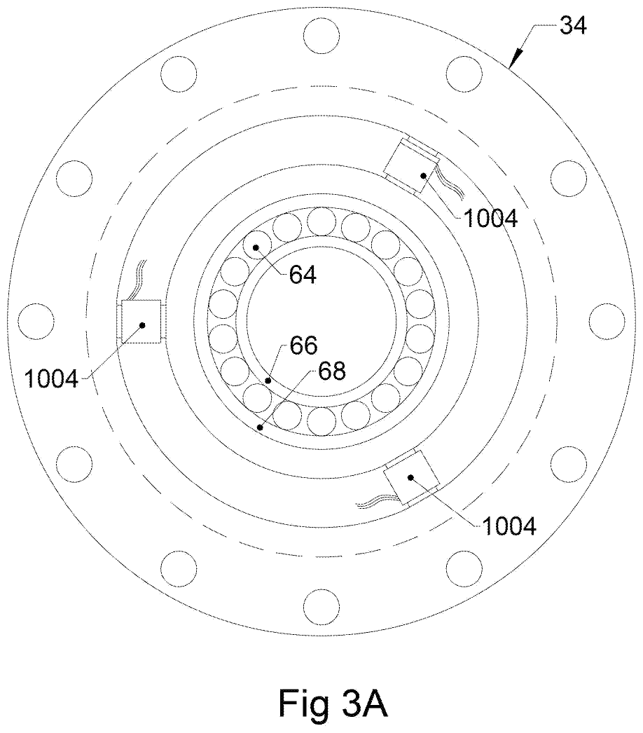

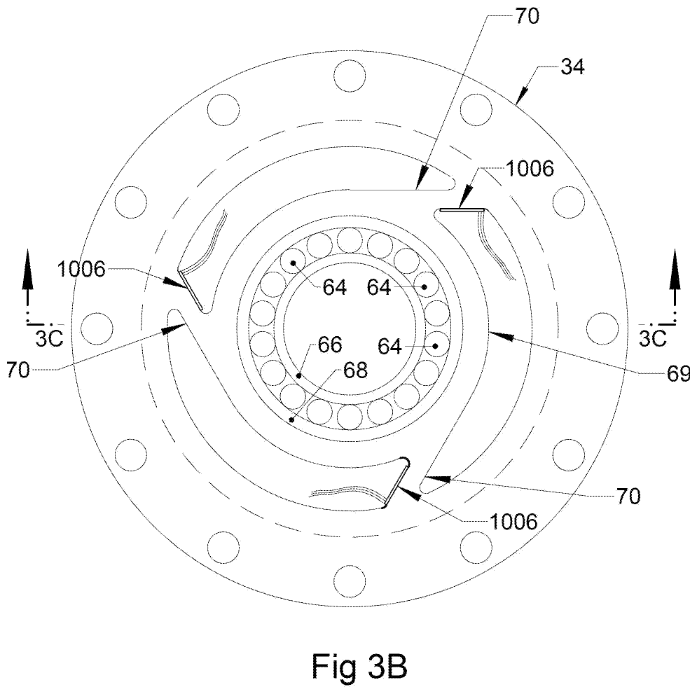

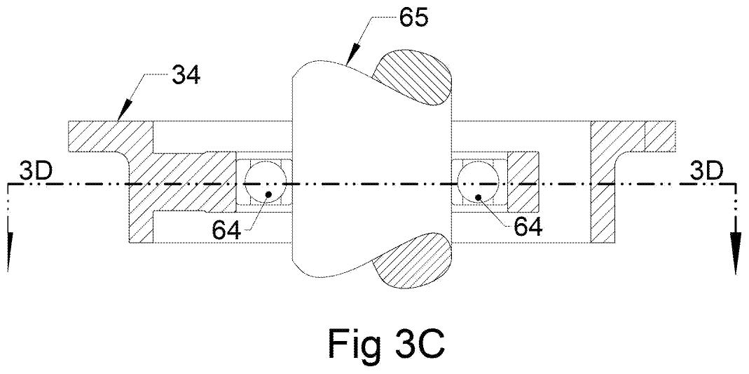

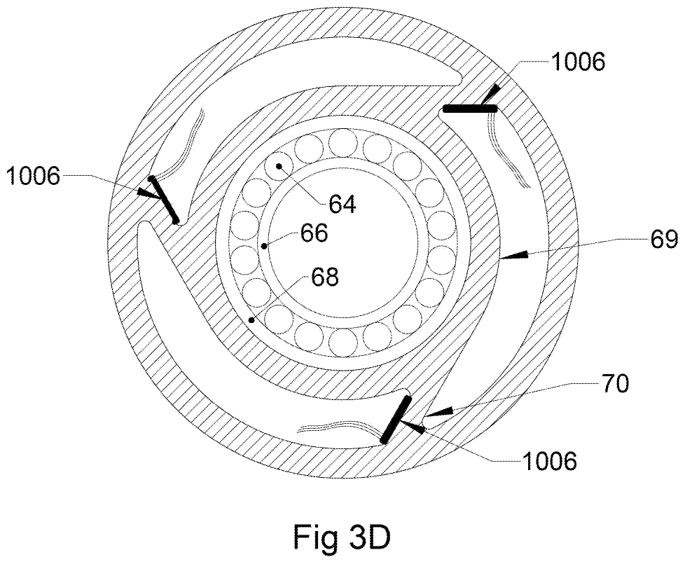

Referring to FIGS. 3A and 3B, there are shown embodiments for reading shaft bending at the bearings for load bearing prime drivers, direct drive motors and load bearing gearboxes or where bearing loads must be determined. Single or multi-axial load cells or strain gauges can be configured to measure forces and moments in one or all directions including those that result in shaft bending forces and thrust forces. The embodiments shown in FIGS. 3A and 3B may be used with load bearing direct drive mixers. FIG. 3A illustrates rolling bearing housing 34 with multi-axial load cells 1004 arranged about the bearing assembly to sense loads. Rolling elements 64 are supported by inner race 66 and outer race 68. FIG. 3C is a cross-sectional view based on the view of FIG. 3B. FIG. 3C shows shaft 65. However, in order to facilitate viewing of the components in FIGS. 3A and 3B, shaft 65 is not shown in FIGS. 3A and 3B. FIGS. 3B, 3C and 3D illustrate another embodiment wherein the rolling bearing housing 34 has strain gauges 1006 that replace multi-axial load cells 1004 and are arranged about the bearing assembly to sense loads. Strain gauges 1006 are mounted on the structural members 70 (e.g., struts) that support and connect the rolling bearing housing 34 to the mounting flange. Specifically, structural members 70 join bearing support ring 69 to bearing housing 34. When the embodiments of FIG. 3A or FIG. 3B are combined with a direct drive load bearing permanent magnet motor or equivalent, the load sensors or strain gauges directly read shaft stress, such as bending, while in a preferred embodiment, the shaft torque can derived from the motor pole data in a direct drive load bearing permanent magnet motor. This can be done with a VFD for certain motors or other motor controller as described in the foregoing description. Shaft torque is directly related to batch viscosity as described in the on-line white paper entitled “Measuring Viscosity of Fresh Concrete by Sensing Torque”, by Datum Electronics, Ltd., Isle of Wight, United Kingdom. Load cells 1004 at the mounting allow for additional resolution, analysis, calculations, redundancy, simplification or elimination depending on what is required to monitor, supervise and qualify the batch and/or the reliability, predict future service or maintenance and also provide technical data that can be used to improve the direct drive system, impeller, shaft or equivalent.

Referring to FIG. 3A, in an exemplary embodiment, in order to sense shaft-bending at the bearings, each load cell 1004 is configured as a one-plane (i.e., one axis: X, Y or Z) load cell. In an exemplary embodiment, these one-plane load cells 1004 are spaced apart by about 120°. In another exemplary embodiment, thrust is sensed at the mounting.

Referring to FIG. 3B, in an exemplary embodiment, in order to sense shaft-bending, each strain gauge 1006 is configured as a one-plane (i.e., one axis: X, Y or Z) strain gauge. Three of these one-plane strain gauges 106 are spaced about 120° apart. In another exemplary embodiment, thrust is sensed at the mounting. (One plane senses bending and two-planes sense both bending and thrust).

Although in the exemplary embodiments of FIGS. 3A and 3B, load cells 1004 and strain gauges 1006 are equidistantly spaced apart by 1200, it is to be understood that these are just exemplary embodiments and that load cells 1004 and strain gauges 1006 may be spaced apart by different distances, may be asymmetrical and not coplanar. and may include more or less than three load cells or strain gauges. The application of these systems is dependent on the accuracy, fidelity, budget and reliability required to control, monitor and supervise the process. It is to be understood that the configurations shown in FIGS. 3A and 3B are not limited to roller bearings and can also be applied to other bearing systems such as tapered bearings, etc.

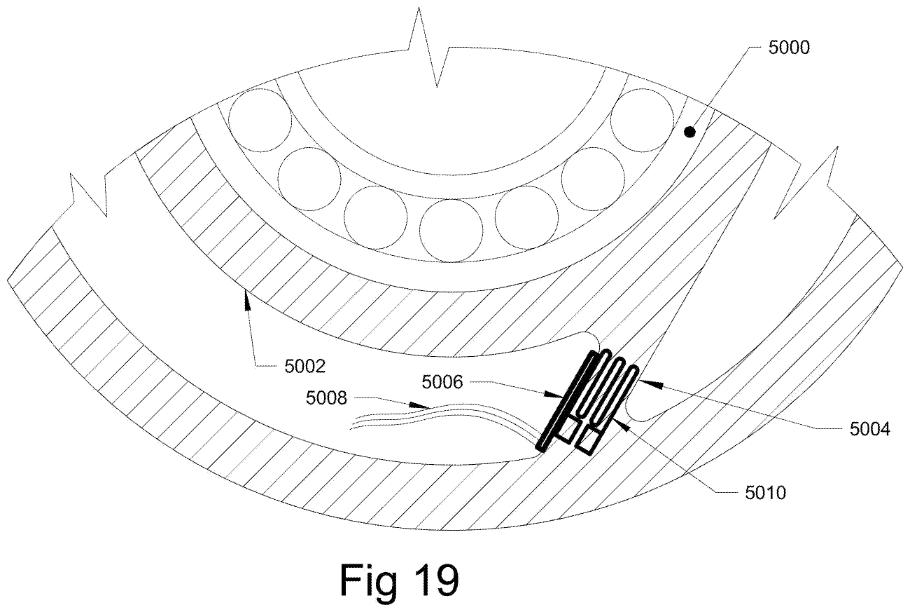

In other embodiments, multi-axis strain gauges or multi-axis load cells are used to sense radial loads, thrust and bending moments and other forces and loads. The embodiments shown in FIGS. 3A-D and FIG. 19 illustrate the utilization of multi-axis load sensors, strain gauges, temperature, vibration and other sensors within the bearing structure. In one example, these embodiments of FIGS. 3A-D and FIG. 19 can be used in the application of shaft bearings of a direct drive propeller of the Magnix Magni 500 Direct Drive Propulsion System to sense vibration, propeller imbalance and a method of balancing the propeller and measuring and predicting impending propeller failure such as after a bird strike.

The ensuing description describes numerous exemplary embodiments of mixer, expander, pump and agitator systems. Some embodiments are directed to systems comprising a combination of a direct-drive mixer and a direct-drive expander, or the combination of a direct-drive mixer and a direct-drive pump. It is to be understood that the motors used in these embodiments may be any of the electric motors discussed in the foregoing description.

The embodiments described in the ensuing description may be load bearing or non-load bearing and may use any type of prime driver, motor or rotor-stator composition or architecture. It is also to be understood that control system 1000 may be used with any or all of these ensuing embodiments. It is should also be understood that control system 1000 may not be used with any of the ensuing embodiments.

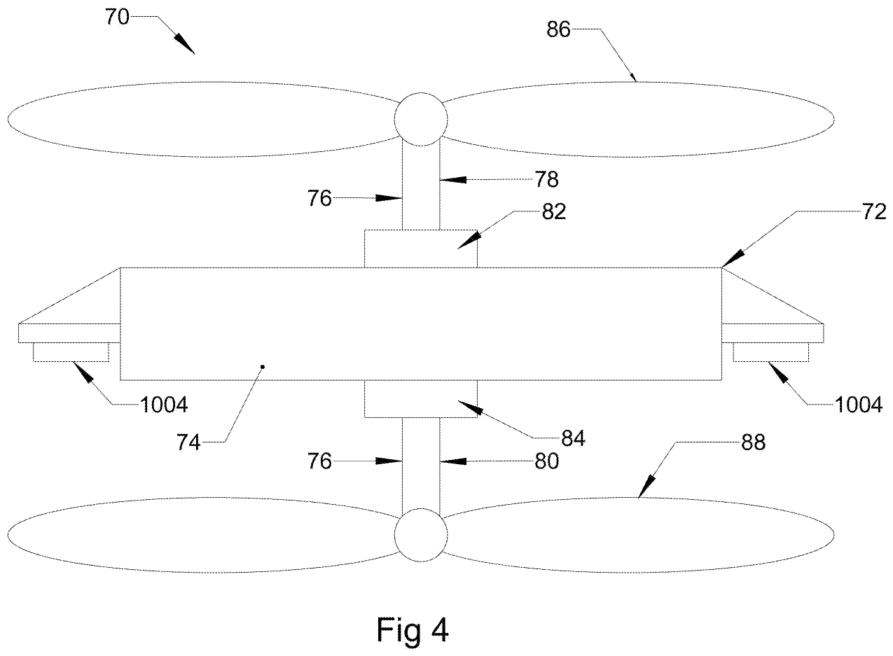

Referring to FIG. 4, there is shown an elevational view of a compact load bearing, direct-drive mixer system 70 in accordance with an exemplary embodiment. In this embodiment, motor 72 comprises a load bearing permanent magnet motor. Motor 72 comprises housing or casing 74 and at least one shaft 76 that extends through housing 74 and has first portion 78 and second portion 80. Shaft 76 is supported for rotation by a first bearing system within bearing housing 82 and second bearing system within bearing housing 84. First impeller 86 is attached to first portion 78 of shaft 76 and second impeller 88 is attached to second portion 80 of shaft 76. In an exemplary embodiment, motor 72 incorporates three coplanar load cells 1004 to provide batch or process feedback in order to control, monitor and supervise the batch for compliance. Since mixer system 70 eliminates the gearbox, it can be configured and mounted in any orientation within the interior of a mixing vessel or conduit and results in reducing the overall length of shaft 76 which also reduces shaft bending and stress. The motor system is free of gearbox contamination and may be located within a batch reactor vessel. The motor system may even be immersed in the batch. In such an embodiment, the batch may cool or heat the motor and the resultant transfer of energy from the motor to the batch may aid in the processing of the batch. The motor shaft can include more than one impeller with different pitches (i.e., forward and reverse) depending on motor rotation (double shaft motor) or a coaxial counter rotating shafts and rotate freely in any direction including agitation which eliminates the need for a current art gearbox and belt and pulley system. An example of coaxial counter rotating shafts is shown in U.S. Pat. No. 2,462,182, entitled “Motor Having A Coaxial Counter Rotating Shafts”. In another embodiment, the motor system is configured as a back-to-back motor system. In an alternate embodiment, the motor system is sealed or encapsulated and only the shafts and impellers are exposed to the mix. Such an alternate embodiment is shown in FIG. 7G which is discussed in the ensuing description.

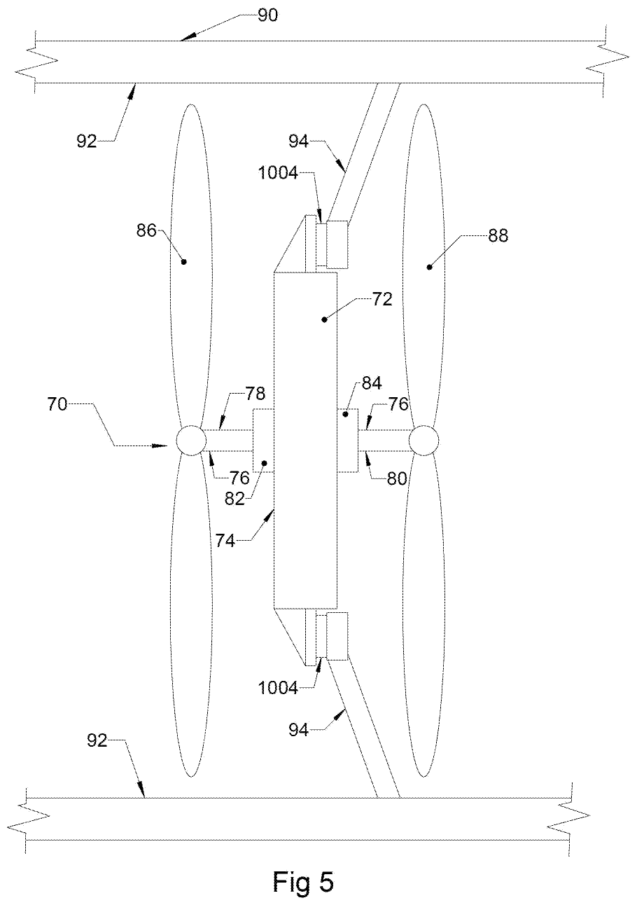

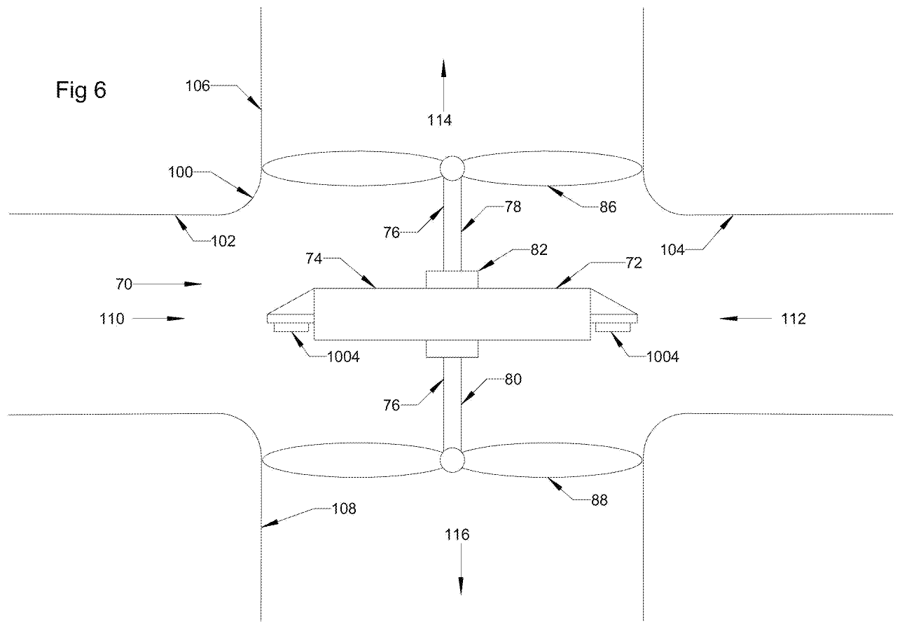

Referring to FIG. 5, there is shown mixer system 70 (originally shown in FIG. 4) mounted within the interior of a conduit, pipe or other annulus 90. Mixer system 70 can provide suction or head to motivate the mix to move through conduit or pipe 90. Application of impellers will depend on the process design parameters. Motor 72 and is attached or joined to interior wall 92 of the conduit 90 via support members 94. Referring to FIG. 6, there is shown mixer system 70 positioned within a multi-channel conduit or pipe network 100 having sections 102, 104, 106 and 108. Incoming batch 110 flows through section 102 toward mixer system 70. Incoming batch 112 flows through section 104 toward mixer system 70. Rotation of impellers 86 and 88 create outgoing batch 114 that flows through section 106 and outgoing batch 116 that flows through section 108. This two-shaft embodiment shown in FIG. 6 may be utilized to create head or suction of the mix while also providing mixing in a multiple channel mixing arrangement of potential ingredients and batch constituents.

Referring to FIGS. 7A and 7B, there is shown a single bearing overhung load bearing. direct-drive mixer 120 in accordance with another exemplary embodiment. By example, since the flow path is an annulus, mixer 120 can be an annulus mixer. Mixer 120 uses high tip speeds to impart maximum force on the medium. Mixer system 120 is positioned within the interior region of pipe or conduit 122. Mixer system 120 comprises at least one motor 124. Motor 124 comprises housing 126 that is attached or joined to interior wall 127 of pipe or conduit 122 via support members 128. Motor 124 further comprises at least one motor shaft 130 and any combination of impellers, blades, disks or other device 134 for pumping, slicing, mixing, chopping, cutting or macerating that are attached to and consecutively arranged upon the motor shaft 130. Motor 124 further includes a plurality of stationary stator elements, vanes, screens or plates 138 which have sizing holes for passing or restricting passage of the medium. Stator elements 138 are attached to and consecutively arranged upon interior wall 127 of pipe or conduit 122. Stator elements 138 form a static mixer or equal. Motor 124 includes bearing housings 139A that house bearings (not shown) that support motor shaft 130. Motor 124 includes a plurality of load cells 1004. In an exemplary embodiment, load cells 1004 are mounted in a tri-axis mounting configuration, wherein each load cell 1004 is interposed between motor housing 126 and a corresponding support member 128. This load cell mounting configuration and the function thereof was discussed in the foregoing description. In a preferred embodiment, motor 124 incorporates three coplanar load cells 1004, which were discussed in the foregoing description, to provide batch or process feedback in order to control, monitor and supervise the batch for compliance. In another embodiment based on the design of the impeller and its testing as previously described, a combination of signals of thrust and torque from load cells 1004 combined with a signal representing impeller rotation and speed would provide an indication of mass flow rate of the batch. Mixer system 120 eliminates the gearbox. Mixer system 120 may be configured and mounted in any orientation within the conduit and results in the reduction of the overall length of shafting 130 allowing for a compact installation and reduced service and maintenance in a confined area. The annulus or conduit maybe comprised of a split casing or a self-contained flange to flange unit as depicted in FIG. 7C. Rotation of impellers 134 creates a flow of the batch composition through the gaps between impellers 134 and stationary stator elements or vanes 138. In an exemplary embodiment, motor 124 is a variable torque, variable speed PMM wherein rotation of the motor and the impellers can be clockwise, counter clockwise or operate in the agitation mode as previously discussed. In another embodiment, the agitation mode may include at least one annular flapper valve arrangement to allow the motor system to agitate while motivating the flow of the batch in a singular direction. Mixer system 120 also may include a plurality of sensors 1002 (not shown) to sense vibration, mass flow and batch temperature and one or more torque sensors (not shown) which were described in the foregoing description and shown in FIG. 13. Motor 124 receives control signals and correction signals from drive device controller 1020 as described in the foregoing description to adjust torque independent from speed to meet process design parameters. In some embodiments, strain gauges 1006 are used in place of load cells 1004.

Referring again to FIGS. 7A and 7B, mixer 120 is located within an annular area that may have a constant diameter or a diameter that varies over a length of pipe so as to expand the diameter to lower the velocity of a process batch. Alternatively, the annular area may have a diameter that tapers over a length of pipe so as to increase the velocity of the medium in a process. Another embodiment could be configured and utilized as a chopper, dicer or macerator in high speed applications wherein the mix or batch may contain solids that are required to be reduced in size and wherein the system utilizes screens for sizing the solids. In one embodiment, a split casing is used wherein the stators are attached to the casing and the motor system has a connected shaft and rotating blades that can be removed and installed into the mounting arrangement with load cells 1004. Stator rows and rotor rows can alternate or follow any sequence. In another embodiment comprises a preconfigured system that is bolted via a flange system between two pipes.

In alternate embodiments, mixer system 120 is configured with multiple stages of rotors (e.g., four stages of rotors). In other embodiments, the mixer system 120 is configured with multiple stages of rotors with at least one of the rotors being counter-rotating.

Another embodiment of mixer 120 is shown in FIGS. 7H and 7I. Mixer 120′ comprises a non-overhung rotor with rear bearing housing 139B that houses rear bearings (not shown). The rear bearings within housing 139B may have a different configuration than the bearings within front bearing housings 139A. For example, the rear bearings within housing 139B may be of a different design such as a radial bearing to allow load cells 1004 to read thrust forces, torque and other loading. Rear bearing housing 139B is supported by rear support structure 129. In an alternate embodiment, strain gauges and load cells 1004 may be added to support structure 129 as required to resolve forces. In a further embodiment, rear support structure may have known structural properties such as spring and stiffness attributes that can be considered through vector analysis, Finite Analysis Methods and testing to resolve mathematically via post processing. Similar to the embodiments shown in FIGS. 4-7A, the motor system shown in FIGS. 7H and 7I is reversible and also provides an “agitator mode” wherein the motor shaft can accelerate and deaccelerate to a set speed or ramp as a function of time and then reverse the shaft direction to another ramp rate or set of various ramp rates as a function of batch viscosity that is measured directly from the motor torque, load cells, torque sensor or equivalent.

Referring to FIG. 7C, there is shown an elevational view, partially in cross-section, of mixer 140 in accordance with another exemplary embodiment. Mixer 140 comprises a rotor-stator system that is similar to an inside-out motor. Mixer 140 can be installed between the pipe sections by flange 142. Mixer 140 comprises rotor 148 which has blades 152. Bearing housings 158 enclose bearing systems that support rotor 148. Stationary stator 150 is supported by outer pipe 146 that is aligned with a pipeline process flow. Alternating mixer stator blades or vanes 156 are located within the inner pipe flow path and are supported by support 144. Rotor 148 rotates with respect to both stationary stator 150 and stationary mixer stator 154 thereby creating a vortex which circulates the batch composition through the gap between the rotor elements 152 and mixer stator blades or vanes 156. Mixer system 140 may incorporate sensors 1002, load cells 1004 or strain gauges 1006 and torque sensors 1010 and may be controlled with system 1000 (see FIG. 13). In an exemplary embodiment, load cells 1004 (not shown) are arranged in the tri-axis mounting configuration which was described in the foregoing description.

Referring to FIG. 7D, there is shown mixer system 160 in accordance with another exemplary embodiment. Mixer 160 is configured with a rotor-stator system that is similar to an inside-out motor-generator. Mixer system 160 provides relatively higher pumping and suction heads thereby requiring higher motor torques and lower speeds with larger annulus flow-paths for motivating higher viscous materials. Mixer system 160 can be installed between the pipe sections by flange 162. Mixer system 160 comprises rotor 168 which has a plurality of blades or rotor elements 172. Bearing housings 176 and 178 enclose bearing systems that support rotor 168. Stationary stator 170 is supported by outer pipe 166 that is aligned with a pipeline process flow. Mixer system 160 includes stationary mixer stator 174 which has a plurality of mixer stator blades or vanes 175 that are located within the inner pipe flow path and are supported by support 164. Rotor 168 rotates with respect to both stationary stator 170 and stationary mixer stator 174 thereby creating a vortex that circulates the batch composition through the gaps between the rotor elements 172 and stator blades or vanes 175. Bearing systems 176 and 178 are interposed between rotor 168 and stator 170 and are lubricated by the process fluid (e.g., fluid in the batch composition). Mixer system 160 incorporates load cells 1004 (not shown). In one embodiment, the load cells 1004 are arranged in the tri-axis mounting configuration described in the foregoing description. Mixer system 160 may also incorporate sensors 1002 and torque sensors 1010 and may be controlled by system 1000 (see FIG. 13).

Referring to FIG. 7E, there is shown a multi-stage mixer system 180 in accordance with another exemplary embodiment. Mixer system 180 is positioned within the interior region of a conduit, pipe or other annulus 181. Conduit 181 has interior wall 182. Mixer system 180 comprises support structure 184 that that supports motor or generator 186. Support structure 184 includes members 187 that are attached or joined to interior wall 182 of conduit 181. Motor or generator 186 comprises casing or housing 188 and rotatable member 190. Rotatable member 190 includes extending vanes or elements 191. Motor or generator 186 comprises bearings that support the rotor (not shown) of motor or generator 186. The rotor is connected to and drives rotatable member 190. Motor or generator 186 includes bearings that are enclosed by bearing housings 192 and 194. Multi-stage mixer system 180 includes stationary stator vanes or elements 196 that are attached or joined to interior wall 182 of conduit 181. Although, mixer system 180 is shown as having four stages, it is to be understood that mixer system 180 may be configured with fewer than four stages or more than four stages. A high-pressure flow of batch composition 198 flows into mixer system 180. Rotation of rotatable member 190 creates a vortex that circulates the high-pressure batch composition 198 through the gaps between the vanes or elements 191 and mixer stator vanes or elements 196 so as to yield low-pressure flow of batch composition 199. Mixer system 180 incorporates load cells 1004 (not shown) that are arranged in the tri-axis mounting configuration described in the foregoing description. Mixer system 180 may also incorporate sensors 1002 and torque sensors 1010 and may be controlled by system (see FIG. 13). In other embodiments, more than one motor is installed along the center line to provide counter rotation and/or provide various torque, speed and directional inputs to the mixer combined with any sequence of stators.

Referring to FIG. 7F, there is shown direct-drive hybrid mixer system 200. System 200 comprises motor 202. Motor 202 is isolated from the mix or batch. Motor 202 includes casing or housing 204, at least one shaft 206 and a plurality of impellers 208 that are attached to shaft 206. Impellers 208 are consecutively arranged on shaft 206. Shaft 206 and impellers 208 are located within interior region 209 of mixing vessel 210. Casing 204 is positioned on the exterior of mixing vessel 210 and is mounted to the exterior side 211 of mixing vessel 210. Shaft 206 has a distal end 212 that is supported by support member 216. Support member 216 is attached or joined to interior wall or surface 219 of mixing vessel 210. Mixer system 200 further includes a plurality of stationary stator vanes 220 that are attached or joined to interior wall 219. Rotation of impellers 208 creates a vortex that causes circulation of the batch composition 221 through the gap between impellers 208 and stationary stator vanes 220. In other embodiments, impeller blades 208 and vanes 220 do not have to alternate sequentially and may include multiple motors, concentric shafts that provide counter rotation to the mix/batch and provide various torque, speed and directional inputs (agitation) to the mix/batch. Shaft 206 may be of any design or configuration. In an exemplary embodiment, mixer system 200 includes load cells 1004 that are arranged in the tri-axis mounting configuration described in the foregoing description. Mixer system 200 may also incorporate sensors 1002 and torque sensors 1010 and may be controlled by system 1000 (see FIG. 13). In some embodiments, strain gauges 1006 are used in place of load cells 1004. Although FIG. 7F shows six impellers 208 and six sets of stationary stator vanes 220, it is to be understood that the quantity of impellers 208 and stator vanes 200 may be varied depending upon the particular application.

Referring to FIG. 7G, there is shown another exemplary embodiment wherein direct-drive mixer 20 of FIG. 1A is used with conduit or pipe network 230 that comprises conduit sections 232, 234 and 236. Direct-drive mixer 20 is positioned at the junction of conduits sections 232, 234 and 236. Motor casing 24 is attached or mounted to the exterior side 238 of conduit network 230. Shaft 26 extends into the interior region of conduit network 230. Incoming batch composition “A” flows inward through conduit 232 and incoming batch composition “B” flows inward through conduit 234. Batch compositions “A” and “B” are mixed by impeller 40 to produce an outgoing mixed or blended batch composition “C”. As discussed in the foregoing description, direct-drive mixer 20 includes load cells 1004. Direct-drive mixer 20 also includes vibration and temperature sensors 1002 and torque sensors 1010 (not shown). Direct-drive mixer 20 is controlled by system 1000 which was described in detail in the foregoing description. In some embodiments, strain gauges 1006 are used in place of load cells 1004.

The embodiments shown in FIGS. 7A-7I may provide feedback for torque, speed, direction as a function of time to evaluate batch viscosity during the mixing input as well as shaft torsion, bending and impeller metrics, such as thrust to evaluate longevity and process effectiveness and batch compliance.

FIGS. 8A and 8C show radial mixers 300 and 350, respectively, that are reversible and can be fed from either direction. In exemplary embodiments, tri-axis load cells 1004 are used as described in the foregoing description. These radial mixers provide high torque and variable speed input to the impeller with feedback such a torque via the motor, load cells or torque sensor. Speed can be determined from an encoder or read directly by a permanent magnet motor or equivalent motor. Using a permanent magnet motor or equivalent motor allows high torque to be provided to the radial impeller while adjusting speed independently to maintain the proper shear in Admix MayoMill® or equal and provide torque feedback and speed through the motor data. Load cells can also provide torque feedback and impeller thrust which may be related to mass flow of mix/batch and may require other adjustments to the upstream input of mix/batch so as to not stall the impeller and maintain proper shear to the mix/batch.

FIG. 8A shows direct-drive radial mixer system 300 that is configured to mix, disperse, emulsify, pulverize, macerate, crush, homogenize and reduce solid particles at high volumes. Direct-drive radial mixer 300 comprises electric motor 302 which has casing 304 and rotatable shaft 306. Impeller 308 is attached to rotatable shaft 306. Motor casing 304 is attached or mounted to the exterior side of conduit or volute 310 at three different mounting flanges, two of which being indicated by reference number 307. In a preferred embodiment, the mounting locations are spaced about 120°. In FIG. 8A, conduit or volute 310 is shown in cross-section. Shaft 306 extends through a hole or opening in conduit or volute 310 such that impeller 308 is located within interior region 312 of conduit or volute 310. Impeller 308 is attached to rotatable shaft 306 by any suitable technique known in the art. In some embodiments, impeller 308 is permanent fixed or attached to rotatable shaft 306. In other embodiments, impeller 308 is removably attached to rotatable shaft 306. In other embodiments, impeller 308 is integral with rotatable shaft 306. Electric motor 302 is configured to provide the proper combination of torque and speed so as to impart forces to the medium flowing through conduit or volute 310. FIG. 8B is a diagram that illustrates the location of load cells 1004 which are arranged in a tri-axial mounting configuration. Load cells 1004 provide continuous measurement of the forces imparted by mixer 300 to the medium flowing conduit or volute 310. Such forces imparted by mixer system 300 to the medium, but are not limited to, radial mixer torque and thrust. Continuous sensing and measurement of these forces by system 1000 allows for the accurate control of mixer system 300 so as to allow adjustment of shear rate or shear capacity for a given medium flowing through conduit or volute 310. In other embodiments, direct-drive radial mixer 300 may be configured as an expander.

FIG. 8C shows direct-drive radial mixer system 350 that is configured for higher process rates. Mixer system 350 is configured to mix, disperse, emulsify, pulverize, macerate, crush, homogenize and reduce solid particles at high volumes. In this embodiment, mixer system 350 comprises motor 352. Motor 352 is configured to provide the proper combination of torque and speed so as to impart forces from radial mixer system 350 to the medium flowing through conduit or volute 354. Motor 352 comprises casing 356 which is attached (e.g., bolted) to the exterior side of conduit or volute 354 at three different mounting flanges, two of which being indicated by reference number 357. In a preferred embodiment, the mounting locations are spaced about 120° Motor 352 comprises a rotatable shaft 358 and shearing head 360 that is attached to rotatable shaft 358. In some embodiments, shearing head 360 is integral with rotatable shaft 358. In an exemplary embodiment, shearing head 360 comprises a shearing head manufactured by Admix, Inc. of Londonderry, N.H. and sold under the trademark Admix MayoMill™. In some embodiments, there is more than one shearing head 360 attached to rotatable shaft 358 so as to provide a plurality of shearing zones. Mixer system 350 includes load cells 1004 that are arranged in a tri-axial mounting configuration. In this embodiment, load cells 1004 are arranged 120° apart. FIG. 8D illustrates the location and arrangement of load cells 1004. Load cells 1004 are part of system 1000 (see FIG. 13) and provide continuous measurement of the forces imparted by radial mixer system 350 to the medium fluid flowing conduit or volute 354. Such forces imparted by radial mixer system 350 to the medium include, but are not limited to, radial mixer torque and thrust. Continuous sensing and measurement of these forces by system 1000 allows for the accurate control of mixer system 350 so as to allow adjustment of shear rate or shear capacity for a given medium flowing through conduit or volute 354. In this embodiment, the shear rate of mixer system 350 may be adjusted by varying the speed (RPM) of motor 352.

In another embodiment, a hydraulic pump is used in place of motor 352. In such an embodiment, the hydraulic pump is configured to provide the proper combination of torque and speed to impart forces from mixer system 350 to the medium flowing through conduit or volute 354.

In another embodiment, a windmill is used in place of motor 352. In such an embodiment, the windmill is configured to provide the proper combination of torque and speed to impart forces from mixer system 350 to the medium flowing through conduit or volute 354.

Referring to FIG. 8E, there is shown an inline radial mixer pump 400 for process flow through a pipeline that is reversible and can be fed from either direction. This radial mixer provides a high torque and variable speed input to the impeller with feedback via the motor, load cells or torque sensor. Speed can be determined from an encoder or read directly by a permanent magnet motor or equivalent motor. Using a permanent magnet motor or equivalent motor allows high torque to be provided to the radial impeller while adjusting speed independently to maintain the proper shear in an Admix Mayo Mill® or equivalent and provide torque feedback and speed through the motor data. Load cells can also provide torque feedback and impeller thrust which may be related to mass flow of mix and may require other adjustments to the upstream input of mix so as to not stall the impeller and maintain proper shear to the mix. Radial mixer 400 comprises vertically oriented motor 402 that has motor mounting flanges 407 which are attached or connected to the exterior side of conduit or volute 404. As shown in FIG. 8F, there are three such motor mounting flanges 407. Motor 402 is configured to provide the proper combination of torque and speed so as to impart forces from system 400 to the medium flowing through conduit or volute 404. Motor 402 comprises casing 406 that is attached (e.g., bolted) to the exterior side of conduit or volute 404. Motor 402 comprises a rotatable shaft 408 that extends through the wall of conduit or volute 404. Impeller 410 is attached to rotatable shaft 408 and is located within interior region 412 of conduit or volute 404. In some embodiments, impeller 410 is integral with rotatable shaft 408. In other embodiments, impeller 410 is removably attached to rotatable shaft 408. System 400 includes multi-axial load cells 1004. FIG. 8F illustrates the location and arrangement of load cells 1004. Each load cell 1004 is mounted adjacent to a corresponding motor mounting flange 407. In an exemplary embodiment, load cells 1004 are arranged 120° apart in a tri-axial arrangement. As discussed in the foregoing description, load cells 1004 are part of system 1000 (see FIG. 13) and provide continuous measurement of the forces imparted by system 400 to the medium flowing through conduit or volute 404. Such forces imparted by system 400 to the medium include, but are not limited to, mixer torque and thrust. Continuous sensing and measurement of these forces by system 1000 allows for the accurate control of system 400 so as to allow adjustment of mixing or expanding capacity for a given medium flowing through conduit or volute 404.

Referring to FIG. 8G, there is shown a diagram of a direct-drive, closed loop process flow mixer/pump system 450 in accordance with another exemplary embodiment. In this embodiment, system 450 utilizes the direct-drive hybrid mixer configuration of FIG. 7F in conjunction with conduit or pipe structure 452 that comprises loop section 454 and valves 456 and 458. A flow of a first medium enters loop section 454 through valve 456. A flow of a second medium enters loop section 454 through valve 458. System 450 comprises motor 460. Motor 460 includes casing or housing 464 and elongated shaft 466. Casing or housing 464 is attached or mounted to the exterior side of conduit or pipe structure 452 by any suitable mounting technique. Shaft 466 extends into the interior region 470 of conduit or pipe structure 452. A plurality of impellers 468 that are attached to elongated shaft 466. Impellers 468 are consecutively arranged on shaft 466. Shaft 466 has distal end 472 that is supported by support member 474. Support member 474 is attached or joined to interior wall 476 of conduit or pipe structure 452. System 450 further includes a plurality of stationary stator vanes 480 that are attached or joined to interior wall 476. Rotation of impellers 468 creates a vortex that causes circulation of the medium through the gap between impellers 468 and stationary stator vanes 480. Although FIG. 8G shows six impellers 468 and six sets of stationary stator vanes 480, it is to be understood that the quantity of impellers 468 and stator vanes 480 may be varied depending upon the particular application. System 450 includes load cells 1004 which are arranged in the tri-axis mounting configuration that has been discussed in the foregoing description. System 450 also includes vibration and temperature sensors 1002 and torque sensors 1010 (not shown). System 450 is controlled by system 1000 (see FIG. 13). In some embodiments, strain gauges 1006 are used in place of load cells 1004. Depending upon the application, drive device controller 1020 may be programmed so that motor 460 rotates in a clockwise direction, counter-clockwise direction or operates in an agitate mode. Such a feature allows system 450 to operate as a pump if required by particular applications.

Mixer/pump system 450 may be configured as a reaction vessel wherein ingredients or components are added into the closed flow path by a shaft driven series of impellers, disks, blades or, as an example, by the mixer system 200 of FIG. 7F, and stator devices may be used to impart forces on a mix or batch. The mix or batch may rotate within the closed flow path in any direction or be agitated or combined with any other embodiment (e.g., mixer 120 of FIG. 7B) to yield the desired result such as batch conformance to the process design. Once the desired result has been achieved the batch can exit through a valve using mixer system 200 of FIG. 7F to pump the mix to the next process. As part of the control supervision of the batch, mixer/pump system 450 may also be configured as a “fixer mixer” where non-compliance batches enter and are fixed by injecting various substances through a valve arrangement into the closed flow path, mixed and then evaluated via the mix feedback and compliance system described herein such as torque feedback and its relationship to mix viscosity. Such injection of substances and components is not limited to a closed flow path embodiment and would be part of a pipeline process throughput involving any of the embodiments disclosed herein including feedback to monitor, supervise, fix in process (i.e., addition or more ingredients), compliance and certification of the process batches.

Referring to FIGS. 8H-J, there is shown a side elevational view, partially in cross-section, of a process flow, radial mixer-pump-expander system 500 in accordance with another exemplary embodiment. In this embodiment, the expander is a regenerative expander. The radial mixer imparts forces to a medium that exits into a volute and enters the expander and/or turbine. The expander reduces the velocity of the medium thereby extracting energy that can be used by the radial mixer. Conduit or pipe 502 is fluidly connected to volute 504. Volute 504 is fluidly connected to flexible joint or interconnecting duct 506. Flexible joint or interconnecting duct 506 is fluidly connected to volute 508. Volute 508 is fluidly connected to conduit or pipe 510. Volutes 504 and 508 may be of any configuration. System 500 includes motor-generator 520 that is mounted to volute 504 at three different mounting locations via mounting flanges 522. The mounting locations are spaced about 120°. At each mounting location, there is a corresponding load cell 1004 interposed between volute 504 and motor-generator 520 such that the combination of the three multi-axial load cells 1004 forms a tri-axial measurement configuration. Motor-generator 520 is mounted to volute 508 via mounting flanges 524. There are three such mounting locations that are spaced 120° apart and there is a load cell 1004 at each mounting location so as to form another tri-axial measurement configuration. Motor-generator 520 includes first shaft 525. Impeller 526 has a plurality of blades 527 and is attached to the end of first shaft 525. Motor-generator 520, first shaft 525, impeller 526 and volute 504 form the radial mixer of system 500. Motor-generator 520 includes second shaft 528. Impeller 530 has a plurality of blades 531 and is attached to the end of second shaft 528. Motor-generator 520, second shaft 528, impeller 530 and volute 508 form the regenerative expander of system 500. Load cells 1004 measures the forces imparted by the radial mixer to the medium flowing through volute 504 and also measures the forces imparted by the flow of the medium on the expander. System 1000 (see FIG. 13) controls system 500. Joint or interconnecting duct 506 has sufficient flexibility and appropriate restraints to substantially reduce the transmission of forces and moments between volutes 504 and 508 so as to ensure that load cells 1004 sense only the interactions between the motor-generator 520 and the volutes 504 and 508 which result from shear forces in the medium and not from any external environmental loads. In some embodiments, force-absorbing mounts (not shown) are used to mount motor-generator 520 in order to resolve forces between the mixer and expander. System 500 is reversible and may be installed in a conduit or pipe network so that either the mixer or expander receives the incoming flow of medium.

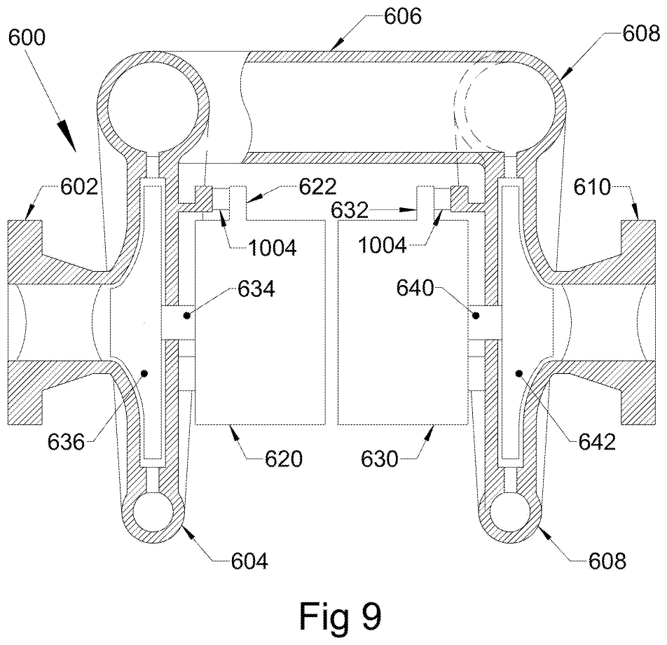

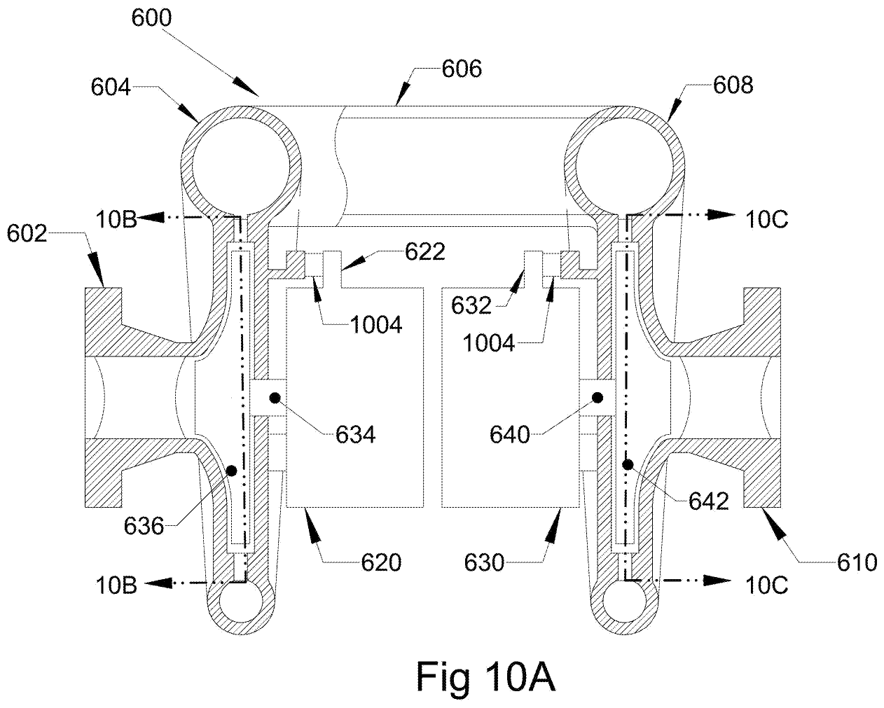

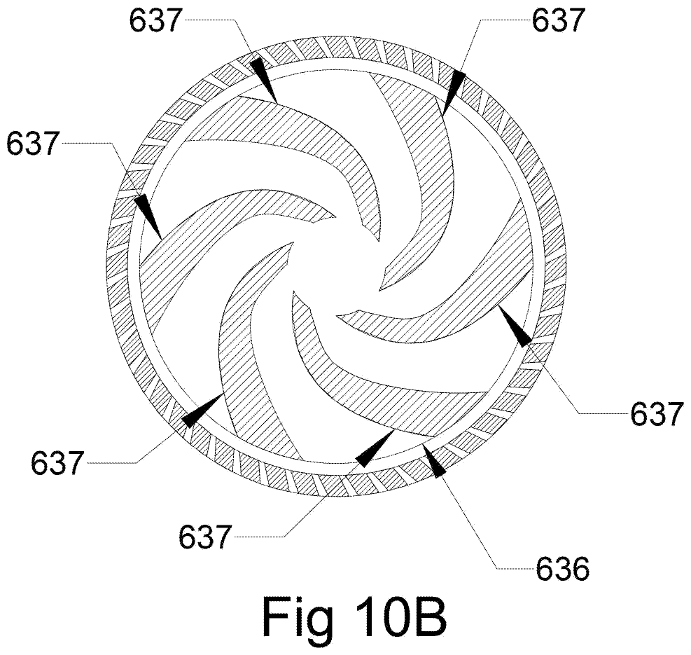

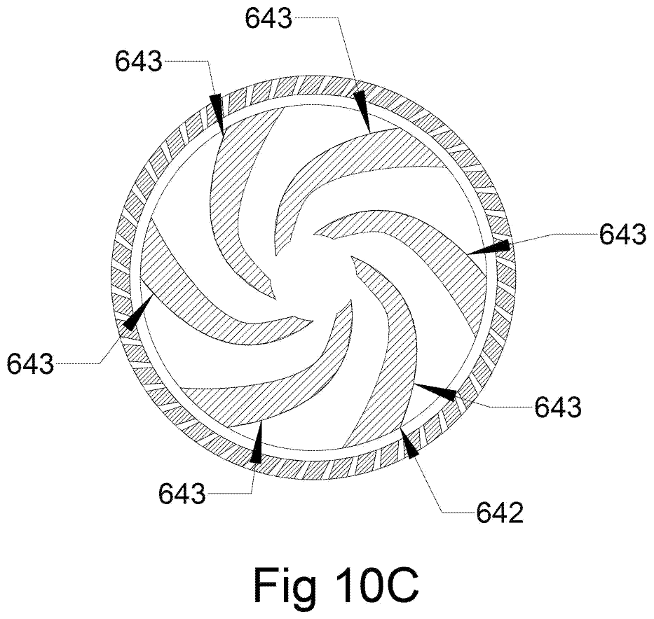

Referring to FIGS. 9, 10A, 10B and 10C, there is shown a process flow radial mixer and expander system 600 in accordance with another exemplary embodiment. In this embodiment, the expander is independent of the radial mixer. In this system, the radial mixer imparts forces to a medium which exits into a volute and then enters the expander. The expander may be used to reduce the velocity of the medium so as to extract energy that may be used by the radial mixer. The expander may operate at a separate speed from the radial mixer. Specifically, system 600 comprises conduit or pipe network 602 that is fluidly connected to volute 604. Volute 604 is fluidly connected to joint or interconnecting duct 606. Joint or interconnecting duct 606 is fluidly connected to volute 608. Volute 608 is fluidly connected to conduit or pipe network 610. Volutes 604 and 608 may be of any configuration. System 600 includes electric motor 620 that is mounted to volute 604 via mounting flanges 622 at three different mounting locations. The mounting locations are spaced about 120°. At each mounting location, there is a corresponding load cell 1004 interposed between volute 604 and motor 620 so that the combination of the three multi-axial load cells 1004 forms a tri-axial measurement configuration. System 600 further includes generator 630 that is mounted to volute 608 via mounting flanges 632 at three different locations. There are also three load cells 1004 spaced 120° apart, at the mounting locations at volute 608, which form a tri-axial measurement configuration. Motor 620 includes shaft 634 that is directly connected to impeller 636. Impeller 636 includes a plurality of blades 637. Motor 620, shaft 634, impeller 636 and volute 604 form the radial mixer of system 600. Generator 630 includes shaft 640 that is directly connected to impeller 642. Impeller 642 has a plurality of blades 643. Generator 630, shaft 640, impeller 642 and volute 608 form the independent expander and/or turbine of system 600. Load cells 1004 measures the forces imparted by the radial mixer to the medium flowing through volute 604 and also measures the forces imparted by the flow of the medium on the expander. System 1000 (see FIG. 13) controls system 600. In this embodiment, generator 630 is also in electrical signal communication with drive device controller 1020. Joint or interconnecting duct 606 has sufficient flexibility and appropriate restraints to substantially reduce the transmission of forces and moments between volutes 604 and 608 so as to ensure that load cells 1004 sense only the interactions between motor 620 and volute 604, and between generator 630 and volute 608 which result from shear forces in the medium and not from any external environmental loads. System 600 is reversible and may be installed in a conduit or pipe network so that either the mixer or expander receives the incoming flow of medium.

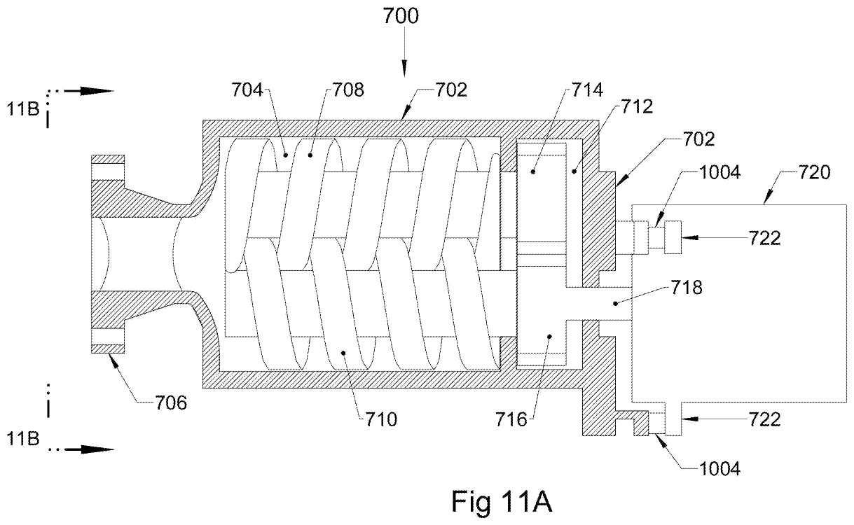

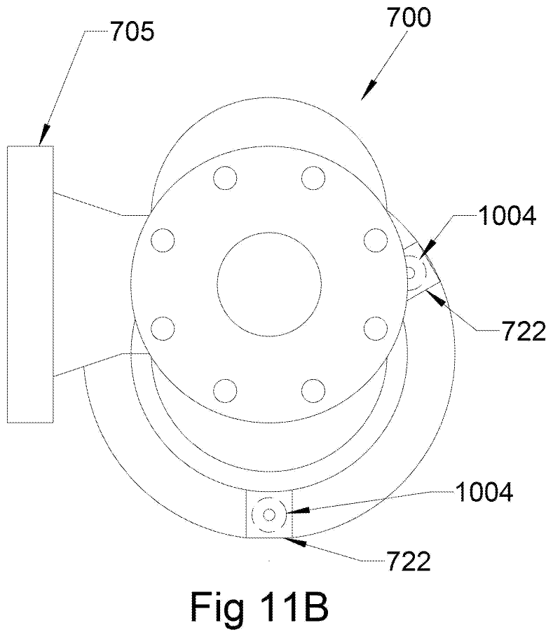

Referring to FIGS. 11A and 11B, there is shown a twin screw pump/mixer/extruder in accordance with another exemplary embodiment. Pump 700 comprises housing 702 which has primary interior region 704, inlet 705 and outlet 706. Inlet 705 and outlet 706 are in communication with primary interior region 704. Feed screws 708 and 710 are positioned within primary interior region 704. Housing 702 includes a secondary interior region 712. Gear wheels 714 and 716 are positioned within second interior region 712. Gear wheel 716 includes drive shaft 718. Pump 700 further comprises electric motor 720 that is directly connected to drive shaft 718 such that electric motor 720 drives both feed screws 708 and 710 simultaneously via the gear wheel to synchronize the feed screws 708 and 710. Electric motor 720 is mounted to housing 702 at three different mounting flanges, two of which being indicated by reference number 722. The mounting locations are spaced about 120°. At each mounting location, there is a corresponding load cell 1004 (shown in phantom in FIG. 11B) interposed between housing 702 and motor 720 such that the combination of the three load cells 1004 forms a tri-axial measurement configuration. Load cells 1004 measure the forces imparted by feed screws 708 and 710 on the medium flowing through pump 700. This load cell mounting configuration and the function thereof were discussed in the foregoing description. In a preferred embodiment, motor 720 incorporates three coplanar load cells 1004 to provide batch or process feedback in order to control, monitor and supervise the batch for compliance. In another embodiment based on the design of the impeller and the testing of the impeller, a combination of signals of thrust and torque from load cells 1004 combined with a signal representing feed screw rotation and speed would provide an indication of mass flow rate of the batch. Mixer system 700 eliminates the current art gearbox and can be configured and mounted in any orientation. This results in reducing the overall length of mixer system 700 thereby allowing for a compact installation and reduced service and maintenance. In an exemplary embodiment, motor 720 is a variable torque, variable speed permanent magnet motor (PMM) wherein rotation of the motor and impellers can be clockwise, counter clockwise or in the agitation mode. In an alternate embodiment, mixer system 700 also includes sensors 1002 to measure vibration, mass flow and batch temperature and torque sensors 1010 (not shown) shown in FIG. 13. Motor 720 receives control signals and correction signals from drive device controller 1020 (see FIG. 13) to adjust torque independent from speed to meet process design parameters. In some embodiments, strain gauges 1006 are used in place of load cells 1004. Pump 700 includes vibration and temperature sensors 1002 and torque sensors 1010 (not shown) and is controlled by control system 1000 (see FIG. 13). In such an embodiment, electric motor 720 is in electrical signal communication with drive device controller 1020. In some embodiments, strain gauges 1006 are used in place of load cells 1004. In other embodiments, drive shaft 718 is configured with lobes or circumferential pistons.

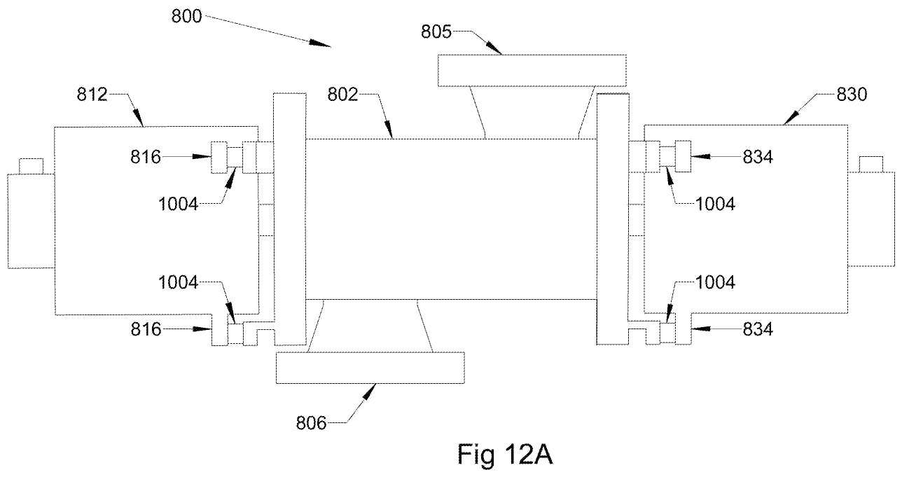

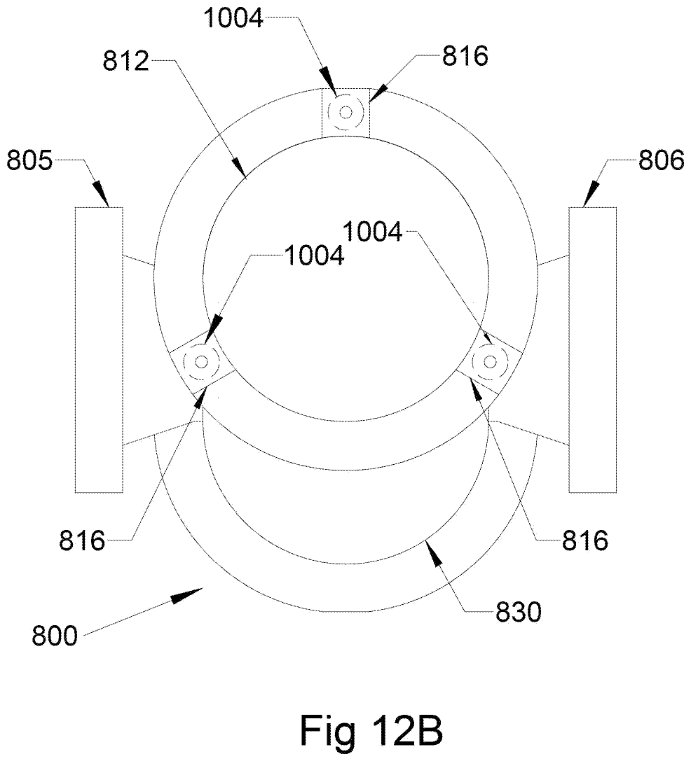

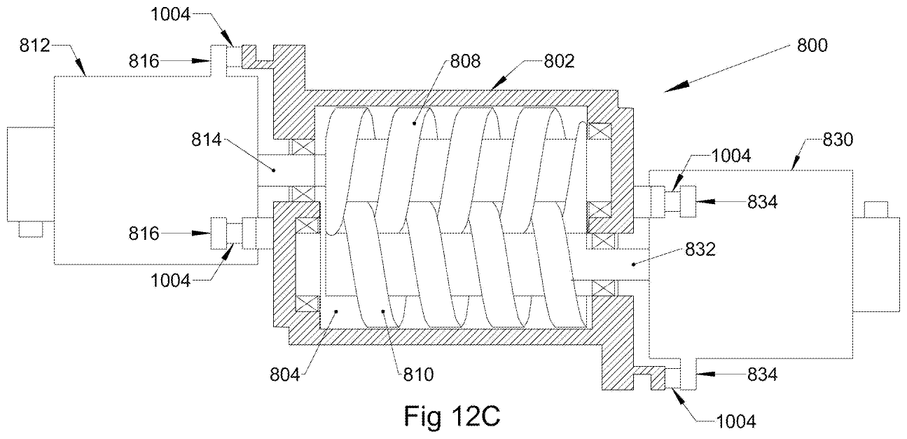

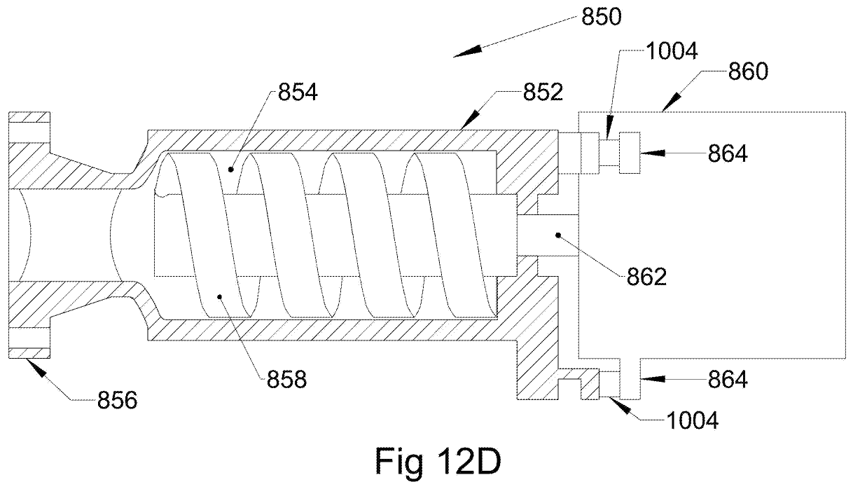

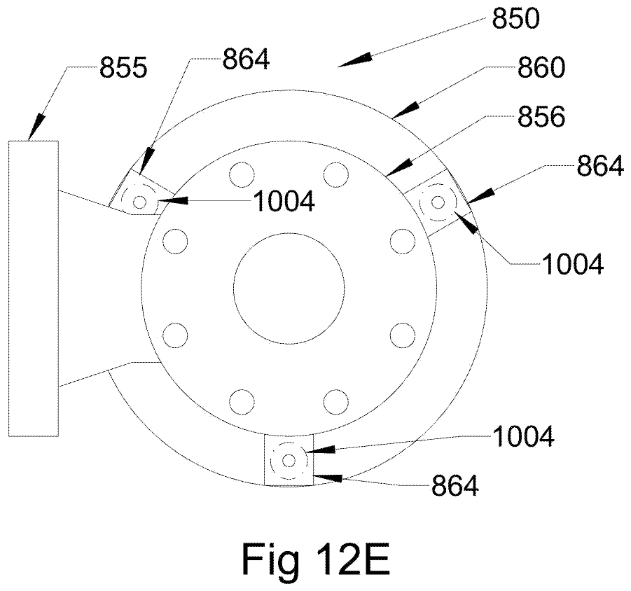

Referring to FIGS. 12A, 12B and 12C, there is shown twin screw pump/mixer/extruder 800 in accordance with another exemplary embodiment. In this embodiment, each screw is driven by a separate direct-drive device such as a permanent magnet motor which provides variable torque independent from variable speed. Specifically, pump 800 comprises housing 802 which has interior region 804. Housing includes ports 805 and 806 that are in communication with interior region 804 as inlets and outlets of the batch flow. Screws 808 and 810 are located within interior region 804. Electric motor 812 has shaft 814 that is directly connected to screw 808 and drives or rotates screws 808. Electric motor 812 is mounted to housing 802 at via mounting flanges 816 at three different mounting locations. The mounting locations are spaced about 120°. At each mounting location, there is a corresponding load cell 1004 interposed between housing 802 and electric motor 812 such that the combination of the three load cells 1004 forms a tri-axial measurement configuration. Load cells 1004 measures the forces imparted by screws 808 on the medium flowing through pump 800. In some embodiments, electric motor 812 is used in conjunction with an absolute position encoder in order to measure the rotating position of screw 808. In other embodiments, electric motor 812 comprises a permanent magnet motor which can measure the rotating position of screw 808. Pump 800 further includes electric motor 830. Electric motor 830 has shaft 832 that is directly connected to screw 810 and drives or rotates screw 810. Electric motor 830 is mounted to housing 802 via mounting flanges 834 at three different mounting locations. The mounting locations 834 are spaced about 120°. At each mounting location, there is a corresponding load cell 1004 (shown in phantom) interposed between housing 802 and motor 830 such that the combination of the three load cells 1004 forms a tri-axial measurement configuration. Load cells 1004 measures the forces imparted by screw 810 on the medium flowing through pump 800. In some embodiments, electric motor 830 is used in conjunction with an absolute position encoder in order to measure the rotating position of screw 810. In some embodiments, electric motor 832 comprises a permanent magnet motor which can measure the rotating position of screw 810. The absolute position encoders and PMM pole data are used with electric motors 812 and 830 to allow for synchronization of screws 808 and 810 in a twin screw extruder to control, monitor and supervise an extruder process. In such an embodiment, the speed extruder provides variable torque independent of variable speed. Control system 1000 (see FIG. 13) may be used to control extruder 800 and includes at least one temperature sensor 1002. Referring to FIGS. 12D and 12E, there is shown direct drive extruder 850 in accordance with an exemplary embodiment. Extruder 850 comprises housing 852 which has interior region 854, inlet 855 and outlet 856. Inlet 855 and outlet 856 are in communication with interior region 854. Feed screw 858 is rotatably positioned within interior region 854. Extruder 850 further comprises electric motor 860. Electric motor 860 has shaft 862 that is directly connected to feed screw 858 such that electric motor 860 directly drives feed screws 858. In an exemplary embodiment, electric motor 860 is mounted to housing 852 via mounting flanges 864 at three different mounting locations. In this embodiment, the mounting locations are spaced about 120°. At each mounting location, there is a corresponding load cell 1004 interposed between housing 852 and motor 860 such that the combination of the three load cells 1004 forms a tri-axial measurement configuration. Load cells 1004 measures the forces imparted by feed screw 858 on the medium flowing through extruder 850. In an exemplary embodiment, extruder 850 includes vibration and temperature sensors 1002 and torque sensors 1010 (not shown in FIG. 12D) and is controlled by control system 1000 (see FIG. 13). In such an embodiment, electric motor 860 is in electrical signal communication with drive device controller 1020. In some embodiments, strain gauges 1006 are used in place of load cells 1004. In some embodiments, electric motor 860 is used in combination with an absolute position encoder in order to measure the rotating position of feed screw 858. In other embodiments, electric motor 860 comprises a permanent magnet motor (PMM) in order to eliminate current art gearbox and provide variable speed independent of variable torque. In such an embodiment, motor pole data provides rotating position and speed of feed screw 858. In combination with PLC and/or control system 1000, torque and thrust measurements from load cells 1004 and temperature sensor 1002 ensure that extruded medium or batch maintains its proper viscosity, composition and temperature in compliance with process specifications thereby avoiding spoilage of the batch. This is paramount in the food industry.

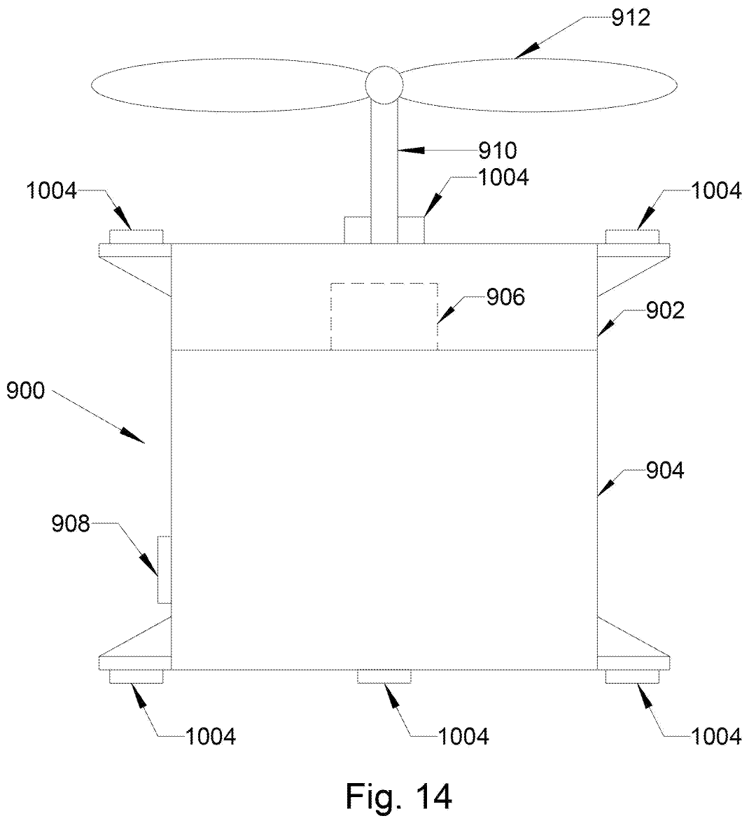

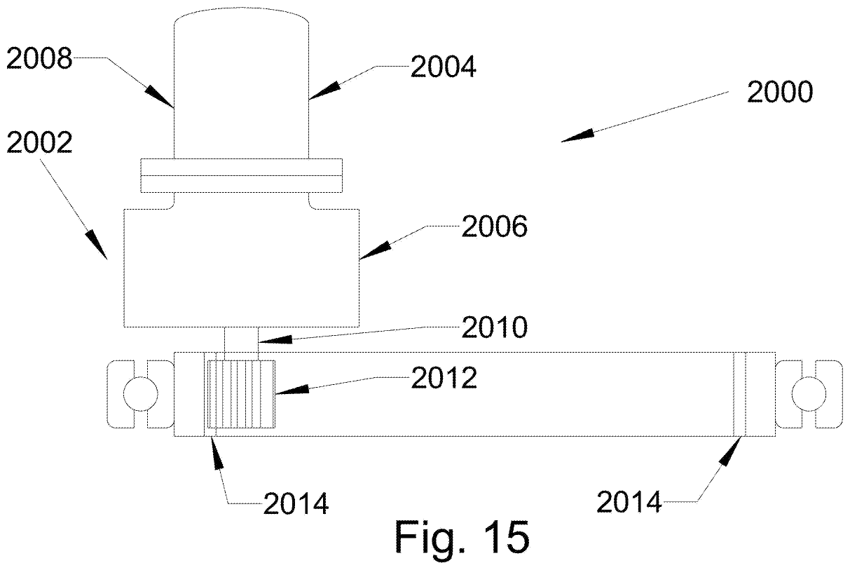

Referring to FIG. 14, there is shown direct drive system 900 in accordance with another exemplary embodiment. Direct drive system 900 may be used to form a mixer, expander, pump and screw pump. Direct drive system 900 generally comprises torque multiplier device 902 and motor 904. Suitable torque multiplier devices are disclosed in the aforementioned U.S. Pat. No. 10,345,056 entitled “Direct-Drive System for Cooling System Fans, Exhaust Blowers and Pumps”. Motor 904 includes a housing (or casing) and rotatable shaft 906 (shown in phantom) that drives torque multiplier device 902. Direct-drive system 900 includes electrical connector 908 which is connected to the motor housing and is electrically connected to drive device controller 1020 to receive electrical power and control signals (see FIG. 13). Torque multiplier device 902 includes rotatable output shaft 910. Impeller 912 is connected to output shaft 910. Motor shaft 906 drives torque multiplier device 902 so as to cause rotation of output shaft 910 and hence, rotation of impeller 912. Load cells 1004 are mounted to torque multiplier device 902 and arranged in a tri-axis mounting configuration which was discussed in the foregoing description. Additional load cells 1004 are mounted to motor 904 and arranged the tri-axis mounting configuration. All load cells 1004 are in electrical signal communication with system 1000. In some embodiments, torque multiplier device 902 is an epicyclic traction drive (ETD) device. Referring to FIG. 15, there is shown a side elevational view of a direct drive municipal drive 2000 for water treatment systems and waste water treatment systems. In this embodiment, direct drive municipal drive 2000 is a clarifier drive for a waste water treatment system. Direct drive municipal drive 2000 comprises direct drive system 2002 which is based on direct drive system 900 which is shown in FIG. 14 which provides variable speed independent of variable torque. Thus, direct drive system 2002 comprises electric motor 2004 and torque multiplier device 2006 which replaces the conventional gearbox. Suitable torque multiplier devices are disclosed in the aforementioned U.S. Pat. No. 10,345,056 entitled “Direct-Drive System for Cooling System Fans, Exhaust Blowers and Pumps”. Motor 2004 includes a housing (or casing) 2008 and a rotatable shaft (not shown) that drives torque multiplier device 2006. Direct drive system 2002 includes an electrical connector (not shown) that is connected to a controller, such as drive device controller 1020 (see FIG. 13) to receive electrical power and control signals. Torque multiplier device 2006 includes rotatable output shaft 2010. Output shaft 2010 is connected to drive pinion 2012. Rotation of output shaft 2010 causes rotation of drive pinion 2012. Drive pinion 2012 is engaged with hoop gear 2014. Rotation of pinion 2012 causes rotation of hoop gear 2014. The combination of the drive pinion 2012 and hoop gear 2014 is disclosed in the aforementioned U.S. Pat. No. 5,264,126, entitled “Clarifier Drive for Waste Water Treatment System”. U.S. Pat. No. 5,264,126 is hereby incorporated by reference in its entirety as if fully set forth herein. A preferred embodiment of a permanent magnet motor (PMM) and load cells 1004 provide the operator with feedback on reduction of solids including icing conditions. Direct drive municipal drive 2000 may be arranged and mounted in a manner similar to the arrangement and mounting of the embodiments shown in FIGS. 1A and 20-22.

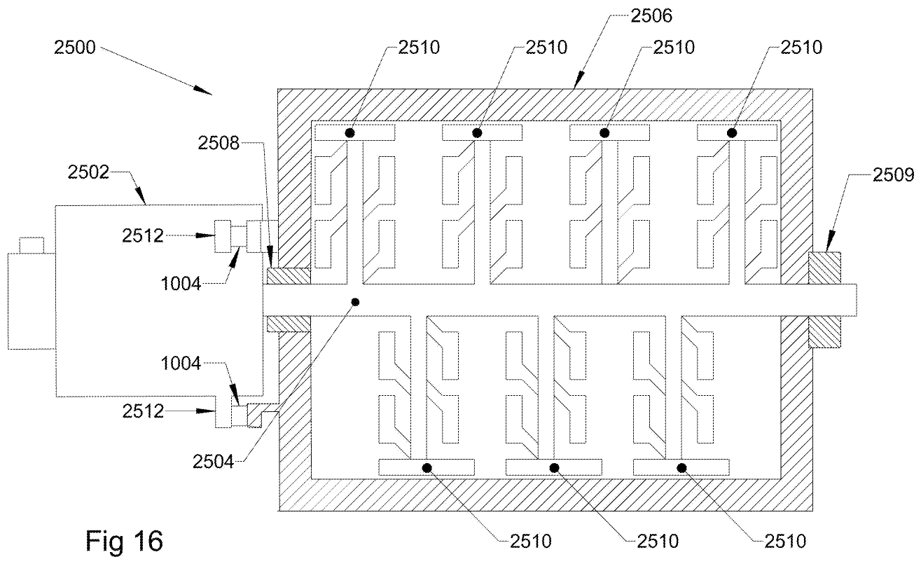

Referring to FIG. 16, there is shown a direct drive horizontal blender 2500 which comprises direct drive motor 2502. Direct drive motor 2502 may be any of the electric motors discussed herein in the foregoing description. Motor 2502 includes shaft 2504 that extends into the interior of vessel or container 2506 and is supported by bearing systems 2508 and 2509. Beater bars (or equivalent) 2510 are connected to shaft 2504. Beater bars 2510 may be of any configuration. The mix or batch is flowed or poured into the interior of vessel 2506. Activation of motor 2502 causes rotation of shaft 2504. The rotating beater bars 2510 blend the mix or batch. In an exemplary embodiment, motor 2502 is mounted to vessel or container 2506 at three different mounting locations, two of which being indicated by reference numbers 2512 and third mounting location not being shown. The mounting locations are spaced apart by about 120°. At each mounting location, there is a corresponding load cell 1004 interposed between vessel 2506 and motor 2502 such that the combination of the three load cells 1004 forms a tri-axial measurement configuration. Load cells 1004 measure the forces imparted by beater bars 2510 on the medium (e.g., mix or batch) within vessel 2506. Control system 1000 (see FIG. 13) or a PLC may be used to control direct drive horizontal blender 2500. In a preferred embodiment, motor 2502 is a PMM which provides variable torque, independent of variable speed and provides a ramp rate at start-up to measure the torque on the shaft to start the system so as not to cause damage or failure of the shaft. This feature is important in the food processing industry during the grinding of hamburger and vessel 2506 is filled with frozen hamburger and an across-the-line start is initiated with the conventional single-speed induction motor and gearbox. The PMM eliminates the problems associated with “across-the-line” starts and leaking gearboxes and provides a soft start and process feedback via load cells 1004 and other sensors, such as a vessel temperature sensor, to determine when the viscosity of the frozen hamburger has been properly mixed and then initiate a soft stop and also provide indication of process compliance to the operator.

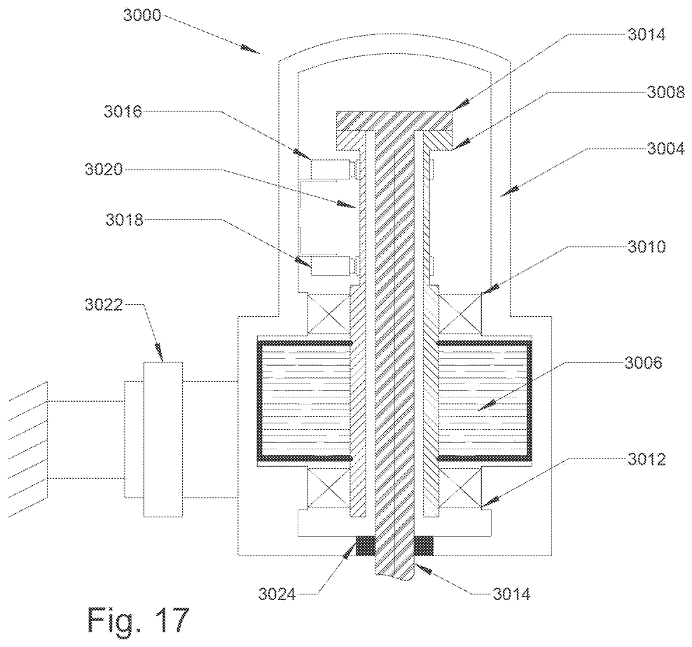

Referring to FIG. 17, there is shown a direct drive mixer system 3000 in accordance with another embodiment. Mixer system 3000 comprises electric motor 3002. Motor 3002 comprises motor housing 3004, a motor and rotor arrangement indicated by reference number 3006 and motor shaft 3008. In some embodiments, motor shaft 3008 is hollow. Motor 3002 includes upper motor bearing 3010, lower motor bearing 3012 and impeller drive shaft 3014. Removable impeller drive shaft 3014 is connected to motor shaft 3008. Motor 3002 includes impeller drive shaft seal 3024. Motor 3000 further includes an optical torque sensor system that comprise optical torque sensors 3016 and 3018. The optical torque sensor system facilitates the reduction of stiffness in torque section 3020. The optical torque sensor system is located at the upper portion of motor 3002 and is protected by motor housing 3004 and/or a separate cover (not shown) in order to protect the electronics from contamination. The optical torque sensor system may also be combined with an optical speed and rotary position sensor system to provide shaft torque, speed and position. Optical torque sensors 3016 and 3018 are commercially available sensors and, in one embodiment, are manufactured by Sensel Measurement of Vincennes. France. In some embodiments, mixer system 3000 includes flange load cell 3022. In some embodiments, flange load cell 3022 is configured as a multi-axis load cell.

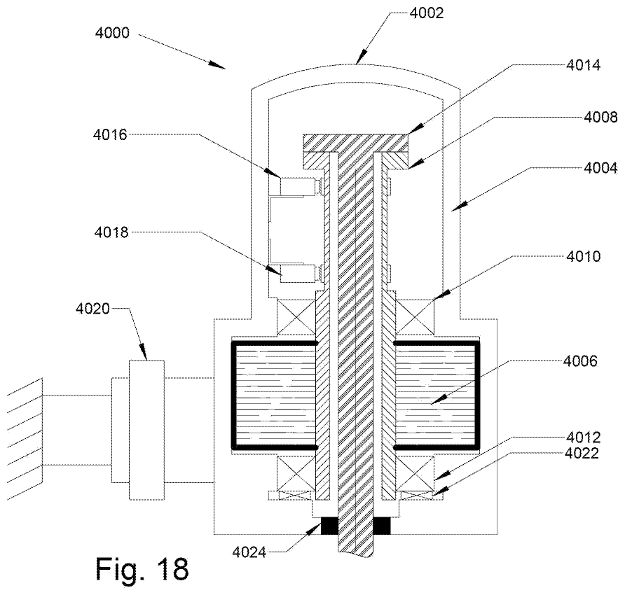

Referring to FIG. 18, there is shown a direct drive mixer system 4000 in accordance with another exemplary embodiment. Mixer system 4000 comprises electric motor 4002. Motor 4002 comprises motor housing 4004, a rotor and stator arrangement indicated by reference number 4006, and motor shaft 4008. In some embodiments, motor shaft 4008 is hollow. Motor 4002 includes upper or top motor bearing 4010. Motor bearing 4010 may be configured as the radial bearing embodiment shown in FIGS. 3A-D. Motor 4002 includes lower bearing 4012 that is configured as a combination thrust/radial bearing. In some embodiments, motor bearing 4012 is the combination of the radial bearing shown in FIGS. 3A-D and bearing 5000 shown in FIG. 19. Referring back to FIG. 18, motor 4000 further includes removable impeller drive shaft 4014 that is engaged with motor shaft 4008. Motor 4002 includes impeller drive shaft seal 4024. Motor 4002 further includes an optical torque sensor system that comprises optical sensors 4016 and 4018. Optical sensors 4016 and 4018 perform the same function and have the same configuration as optical sensors 3016 and 3018, respectively, shown in FIG. 17. In some embodiments, mixer system 4000 includes multi-axis flange load cell 4020. In other embodiments, mixer system 4000 includes load cells 4022 located at the lower bearing 4012.

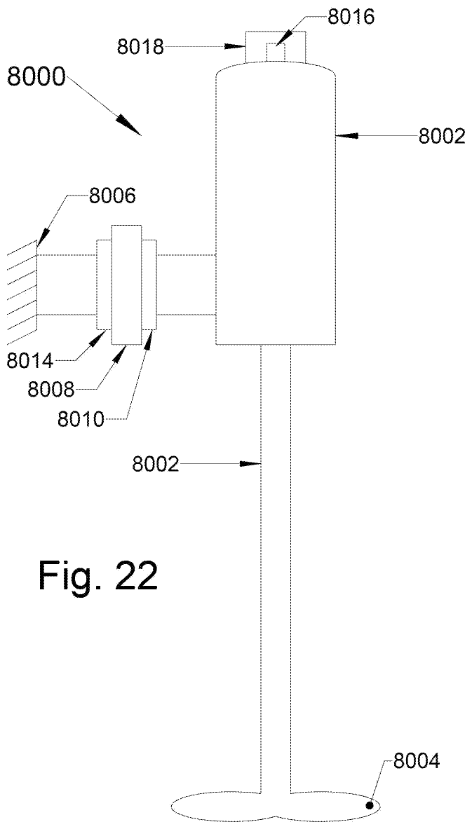

Referring to FIG. 19, there is shown bearing 5000 which in this embodiment is a bearing that reacts both thrust and radial loads and has support ring 5002 and structural support members 5004 that are integral with support ring 5002. In this embodiment, structural support members 5004 are equally spaced apart by 120° and includes at least one strain gauge 5010 to measure thrust. Radial strain gauge 5006 is mounted or joined to a corresponding structural support member 5004 and includes at least one strain gauge with a preferred embodiment of three coplanar radial strain gauges 5006 equal spaced apart by 120 degrees as recited in previous embodiments. Other embodiment may include single or multi-axis load cells and/or radial and/or axial strain gauges that are located in various planes and locations on the bearing and their feedback or signals used as an on/off signal to a PLC by example or resolved by vector analysis or other means to determine forces and moments on the bearing system and by example those feedback signals can be sent to control system 1000. Each strain gauge 5006 and 5010 includes wires or cables 5008 to provide signals to a PLC, signal acquisition and/or signal processing components or devices. Each single axis strain gauge 5010 is positioned, mounted or joined to a corresponding structural support member 5004. For a shaft supported by bearings, such as a gearbox, the systems disclosed in FIGS. 3A-D combined with the strain gauge configuration shown in FIG. 19 could be incorporated into the gearbox bearing system to measure the impeller shaft radial and thrust loads. The bearings could also be applied to the embodiment shown in FIG. 14 as well as a non-load bearing motor embodiment where the bearings are applied to the driven impeller shaft to measure both radial and thrust loads at the bearing. The strain gauges can also be substituted and/or additional gauges or any type of sensors added to the bearings in FIG. 14, FIG. 19 and FIGS. 3A-D to measure position, displacement, velocity, acceleration and vibration of the bearing, shaft or prime driver system. When bearing 5000 of FIG. 19 is combined with the embodiments FIG. 17, FIG. 18 and FIG. 22, the direct drive mixer with removable impeller shaft can provide signals for torque, speed, vibration, displacement, thrust and radial loading.

If a permanent magnet motor (PMM) is used with the embodiments shown in FIGS. 3A, 3B, 3D and 17-19, then the force, torque and speed may be read from the PMM as described in the foregoing description.

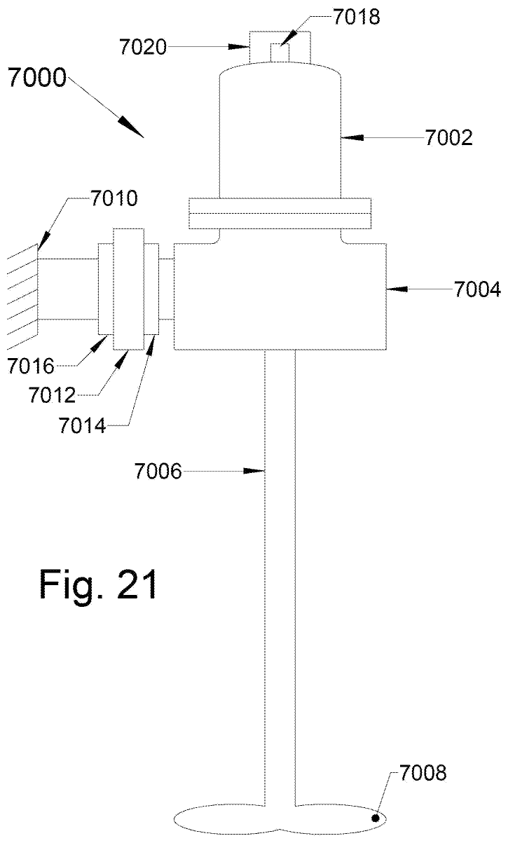

Referring to FIG. 21, there is shown mixer system 7000 in accordance with another exemplary embodiment. Mixer system 7000 comprises motor 7002 that drives gearbox 7004. Impeller shaft 7006 is connected to gearbox 7004. Impeller blades 7008 are at the end of impeller shaft 7006. Mixer system 7000 is mounted at a single rigid point 7010. Multi-axis load cell 7012 is located between gearbox mounting flange 7014 and rigid mounting flange 7016. Rigid mounting flange 7016 is mounted or attached to fixed point 7010. Mixer system 7000 includes torque sensor 7018 mounted to motor 7002. Multi-axis load cell 7012 can measure several parameters including thrust. In some embodiments, gearbox sensors are used to read the forces in gearbox 7004. In an exemplary embodiment, motor 7002 is a single speed motor. In other embodiments, motor 7002 is variable speed motor. In an alternate embodiment, an optical sensor is used on gearbox 7004 to read the torque of gearbox 7004. In some embodiments, mixer system 7000 includes a protected encoder to read the speed of impeller shaft 7006.

Referring to FIG. 22, there is shown direct-drive mixer system 8000 in accordance with another exemplary embodiment. Mixer system 8000 comprises motor 8002 that directly drives an impeller shaft 8002. Impeller blades 8004 are located at the end of impeller shaft 8002. Mixer system 8000 is mounted at one fixed point 8006. In an exemplary embodiment, multi-axis load cell 8008 is attached to and between motor mounting flange 8010 and rigid mounting flange 8014. Rigid mounting flange 8014 is rigidly mounted to rigid point 8006. Mixer system 8000 further includes torque sensor 8016 which is mounted to motor 8002. Torque sensor 8016 is protected by cover 8018 which is removably attached to motor 8002 by any suitable technique. In an exemplary embodiment, motor 8002 is a non-load bearing induction motor. In another embodiment, motor 8002 incorporates a protected encoder for reading the speed and position of impeller shaft 8002. In other embodiments, motor 8002 may be a different type of motor, e.g. permanent magnet motor. As presented previously, one or more sensors may be used to generate a signal equivalent to shaft torque, shaft speed, shaft thrust and shaft moments. Motor 8002 may be a load bearing motor or a non-load bearing motor.

FIG. 23 is a graph of torque as a function of time for a given process design. The information provided by FIG. 23 results from the utilization of protected sensors (i.e. protected from the batch) to measure batch and process parameters during the mixing process and throughout the mixing cycle including process batch transportation, environmental factors (e.g. heat and cold), expansion, and energy recovery. Torque is measured by one or more sensors or the techniques and methods described in the foregoing description. As previously described herein, torque is a function of batch viscosity and/or speed. The graph in FIG. 23 shows a number of process inputs such as (i) injecting substance A into batch at Time T1, (ii) adding heat to the batch and/or process at Time T2, and (iii) adding a catalyst at Time T3. The solid graph line is the process design which needs to be followed for batch compliance. The data points on the graph are the actual measured points from the sensors and depict the variance from the process design graph. The graph in FIG. 23 also depicts a programmable soft start of the mixer from rime=0.0. Based on batch chemical design, analytics, testing, characterization, validation as described, trending the impeller torque and/or speed feedback over time will indicate each batch and/or process compliance to the process design. Trending the impeller torque, speed and other process parameters over time will provide process variance, tolerance and other Statistical Process Controls (SPC) and quality control methods. Combined with the process design, analytic, testing, characterization and validation that is invested into each process, process data and feedback via the protected sensors and other methods provide data to measure the process, evaluate the process and control the process. The process can now benefit from closed loop data and analytics and provide compliance to the process design according to the curve of the graph in FIG. 23. The feedback from the protected sensors also provides data and analytics to improve the process per SPC methods and ISO9000. SPC method and ISO9000 standards are well known and are therefore not discussed herein. The sensors, combined with well-known analytics to measure and trend wear and tear on the mixing system software and hardware also provides health monitoring and feedback of the system such as wear and tear on the impeller. Such information alerts the operators that the impeller must be replaced. Such information also may be used to redesign and improve the impeller. Such improvements may include improved materials for improved mixing performance.

The foregoing description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible for direct drive compressors, turbines, expanders and screw compressors. In addition, many embodiments disclosed herein can be re-configured as a turbine to extract energy from a continuous process while still providing mixing assuming that the head in the pipe is sufficient. The embodiments shown in FIGS. 11A and 12A, 12D can also be configured as direct drive screw compressors. While the disclosed subject matter has been described in connection with various embodiments and corresponding Figures, where applicable, it is to be understood that other similar embodiments can be used or modifications and additions can be made to the described embodiments for performing the same, similar, alternative or substitute function of the disclosed subject matter without deviating therefrom. Accordingly, the disclosed subject matter should not be limited to any single embodiment described herein.

What is claimed is:

1. A direct drive batch mixing system, comprising:
a vessel having an interior region configured to receive a batch;
a direct drive electric motor attached to at least one rigid point;
a multi-axis load cell located between the motor and the rigid point to provide signals representing forces and moments in multiple axes;
an impeller located within the interior region of the vessel and engaged with the motor such that the motor rotates the impeller; and
wherein loads and forces on the impeller are directly supported by the motor and measured by the multi-axis load cell.

2. The direct drive batch mixing system according to claim 1 wherein the motor is a variable speed motor.

3. The direct drive batch mixing system according to claim 1 wherein the motor is configured to operate in a forward rotational direction and in a reverse rotational direction.

4. The direct drive batch mixing system according to claim 1 wherein the motor includes a rotatable shaft and wherein the impeller is connected to the rotatable shaft.

5. The direct drive batch mixing system according to claim 1 wherein the motor further comprises:
a casing:
a motor flange attached to the casing; and
wherein the multi-axis load cell is mounted between the motor flange and a rigid flange attached to the rigid point.

6. The direct drive batch mixing system according to claim 1 wherein the multi-axis load cell is a six-axis load cell.

7. The direct drive batch mixing system according to claim 1 further comprising a programmable motor controller having an input for receiving AC power and an output for providing electrical signals that control the operational speed (RPM), torque and directional rotation of the motor, the programmable motor controller being further configured to receive feedback signals to adjust to adjust the operational speed and/or torque and/or rotational direction of the motor.

8. The direct drive batch mixer system according to claim 7 further comprising:
a motor torque sensor that provides signals representing motor torque; and
a data acquisition device (DAQ) that is in electrical signal communication with the programmable motor controller, the multi-axis load cell and the motor torque sensor.

9. The direct drive batch mixer system according to claim 8 further comprising a signal processor in data signal communication with the data acquisition device (DAQ), the signal processor comprising:
at least one processor;
at least one data storage device for storing predefined parameters; and
wherein the processor is programmed to process data signals received by the digital acquisition device (DAQ) to determine values based on the parameters sensed by the multi-axis load cell, the torque sensor and motor data provided by the programmable motor controller and then compare the determined values to the stored predefined values to determine the efficiency of the mixing process and the health of the motor and also to determine if adjustments to the mixing process or motor are necessary.

10. The direct drive batch mixer system according to claim 9 wherein the signal processor is configured to generate alert signals that alert operators of significant changes in the mixing process or the performance of components of the direct-drive batch mixing system.

11. The direct drive batch mixer system according to claim 9 further comprising:
vibrations sensors to sense vibrations of the motor, impeller, vessel, batch inflow conduits and batch outflow conduits and output signals representing the sensed vibrations;
wherein the data acquisition device (DAQ) is in electrical signal communicating with the vibrations sensors; and
wherein the signal processor is further configured to process the signals outputted by the vibration sensors.

12. The direct drive batch mixer system according to claim 1 wherein the motor is mounted to a plurality of rigid points and the direct drive batch mixing system further comprises a plurality of multi-axis load cells, wherein each multi-axis load cell provides signals representing forces and moments in multiple axes and wherein each multi-axis load cell is positioned between the motor and a corresponding rigid point.
